(19) United States
(12) Patent Application Publication
(10) Pub. No.: US 2010/0246014 A1
(43) Pub. Date: Sep. 30, 2010

(54) ANTIREFLECTIVE FILM, POLARIZING PLATE, IMAGE DISPLAY DEVICE AND COATING COMPOSITION FOR FORMING LOW REFRACTIVE INDEX LAYER

(75) Inventors: Miho ASAHI, Minami-Ashigara-shi (JP); Hiroyuki YONEYAMA, Minami-Ashigara-shi (JP); Daiki WAKIZAKA, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/750,804

(22) Filed: Mar. 31, 2010

(30) Foreign Application Priority Data
Mar. 31, 2009 (JP) 2009-088408

(51) Int. Cl. G02B 1/11; B32B 27/00; C09D 4/00

(52) U.S. Cl. 359/585; 428/422; 428/313.9; 428/323; 524/851; 359/580

(57) ABSTRACT

An antireflective film includes: a transparent substrate film; and at least one low refractive index layer, the low refractive index layer is formed with a composition containing: a fluorine-containing antifouling agent having a weight average molecular weight of less than 10,000 and a structure represented by the following formula (F); a polyfunctional monomer having a polymerizable unsaturated group; and (C) an inorganic particle, and a content of the fluorine-containing antifouling agent is 1% by weight or more and less than 25% by weight based on a total solid content of the coating composition:

(Rf)-[(W)-(R_{A})ₙ]ₘ Formula (F)
wherein, Rf represents a (per)fluoroalkyl group or a (per)fluoropolyether group, W represents a connecting group, R_{A} represents a functional group having a polymerizable unsaturated group, n represents an integer of from 1 to 3, and m represents an integer of from 1 to 3.

### CROSS-REFERENCE TO RELATED APPLICATIONS

This application claims the benefit of Japanese Patent Application JP 2009-088408, filed Mar. 31, 2009, the entire content of which is hereby incorporated by reference, the same as if set forth at length.

### FIELD OF THE INVENTION

The present invention relates to an antireflective film, a polarizing plate using the antireflective film, and an image display device using the antireflective film or the polarizing plate on the outermost surface of the display.

### BACKGROUND OF THE INVENTION

In an image display device, for example, a cathode ray tube display (CRT), a plasma display (PDP), an electroluminescence display (ELD) and a liquid crystal display (LCD), an antireflective film is ordinarily provided on the outermost surface of the display for reducing reflectivity using the principle of optical interference, in order to prevent contrast reduction or reflected glare image due to the reflection of the outside light. Thus, the antireflective film is required to have a high antifouling property against a fat or oil component, for example, a fingerprint or sebum, high physical strength (for example, scratch resistance), high transmittance, chemical resistance and weather resistance (for example, moisture/heat resistance or light resistance), in addition to the high antireflective performance.

As for the production of the antireflective film, although various methods including a wet type method and a dry type method have been known, in order to produce more efficiently a large size antireflective film a method of coating a composition prepared by dissolving components for forming the antireflective film in a solvent on a substrate film is used. According to the method, the antireflective film is produced by coating at a time on a long roll and rolled up to preserve in the form of roll. Therefore, since the central part of the roll is subjected to a large load and films are strongly winded each other, it is also required that transfer of the components from the coated surface to the rare surface coming into close contact with each other is prevented. When the transfer occurs, in a step of sticking the antireflective film on a polarizer as a surface protective film of the polarizer at the production of polarizing plate, sufficient adhesion between the antireflective film and the polarizer is not achieved to cause peeling in some cases, resulting in decrease of the production efficiency. Therefore, it is extremely important to control the transfer amount below a certain value.

As a technology for imparting the antifouling property, there has been ordinarily known a method of reducing the surface free energy of a coated film surface using a silicone compound having a polydimethylsiloxane structure or a fluorine-based compound. In particular, since the fluorine-based compound exhibits a large effect of reducing the surface free energy, it is effective to generate the antifouling property.

For example, it is proposed that a compound having a long-chain fluorine-containing polyether chain and an unsaturated double bond is used in an antireflective film so as to impart an antifouling performance without accompanying deterioration of the low refractivity and the hardness (WO 2003/022906).

However, since the compound described in WO 2003/022906 is also distributed inside the cured film obtained by coating a composition containing the compound, followed by curing, it is necessary to incorporate a large amount of the compound into the film in order to impart the sufficient antifouling property on the surface of the film and as a result, the film strength decreases to make the scratch resistance insufficient. Also, the compound is not always sufficient in view of the transfer property.

Methods of improving the scratch resistance while using a compound having a fluorine-containing alkyl chain or a fluorine-containing polyether chain are proposed, for example, in JP-A-2005-99778 (the term “JP-A” as used herein means an “unexamined published Japanese patent application”) and JP-A-2008-9348. However, these methods do not satisfy the antifouling property and transfer property and further improvements have been requested.

Further, in the antireflective film described above, a low refractive index layer which is a thin film layer having a thickness of 200 nm or less is provided on the outermost surface furthest away from the substrate film, and the antireflection is effected by the optical interference of the low refractive index layer. It is known, however, that the surface migration property of the fluorine-based antifouling agent decreases as the thickness of layer decreases. Thus, it is difficult to impart the antifouling property without accompanying degradation of the scratch resistance, transfer property and optical properties of the low refractive index layer. Further, in order to decrease the refractive index, means for using a fluorine-containing compound as a binder for a coating composition for forming the low refractive index layer is broadly employed. However, when such a binder is used, the surface migration property of the fluorine-based antifouling agent further decreases.

In addition, in the case of using a fluorine-containing compound as the binder, both the fluorine-based antifouling agent and the fluorine-containing compound as the binder exist in the neighborhood of the surface and these compounds are not mixed but cause phase separation to form a sea-island structure in some cases. When the sea-island structure is formed, there is a risk of decreasing the antifouling property and the scratch resistance and further improvements have been requested.

Further, in the case of a one-layer thin film interference type antireflective film for effecting antireflection by one layer of the low refractive index layer which have the simplest structure, there is no practical low refractive index material satisfying a reflectivity of 0.5% or less and having a neutral tint and high scratch resistance. On the contrary, there has been known a multi-layer thin film interference type antireflective film for preventing the reflection by multi-layer optical interference, for example, a two-layer thin film interference type for forming a high refractive index layer between a transparent substrate film and a low refractive index layer or a three-layer thin film interference type for forming a medium refractive index layer and a high refractive index layer in order between a transparent substrate film and a low refractive index layer in order to attain the reflectivity of 0.5% or less.

However, such a multilayer-type antireflective film can reduce the reflection, but a fluctuation in the layer thickness or the refractive index of each of the layers leads to a change in the reflected color. Particularly, when a fingerprint or sebum is attached on the surface of a coated film, even if it is wiped off, some residue of the fat or oil component, if any, remains, and thus, it is noticeable because the attachment trace is more readily recognized as the change in the tint based on the change in the refractive index in comparison with the one-layer type antireflective film, thereby reducing the visibility of the image. Therefore, in a conventional multi-layer type antireflective film, the antifouling property can not be satisfied even when the fluorine-based compound having water/oil repellency or the silicone compound having a polydimethylsiloxane structure described above is used.

### SUMMARY OF THE INVENTION

An object of the present invention is to provide a coating composition for forming a low refractive index layer to form a low refractive index layer which is also excellent in view of the antifouling property and the transfer property while maintaining the low reflectivity and scratch resistance when the low refractive index layer is formed using a fluorine-containing compound having high water/oil repellency. Another object of the invention is to provide an antireflective film having the low refractive index layer, a polarizing plate having the antireflective film and an image display device.

As a result of the intensive investigations in order to solve the above-described problems, the inventors have found that the above-described objects can be achieved by the constructions described below to complete the present invention.

(1) An antireflective film comprising a transparent substrate film and at least one low refractive index layer, wherein the low refractive index layer is formed from a composition containing at least (A) a fluorine-containing antifouling agent having a weight average molecular weight (Mw) of less than 10,000, a polymerizable unsaturated group and a structure represented by formula (F) shown below, (B) a polyfunctional monomer having a polymerizable unsaturated group and (C) an inorganic fine particle, and a content of the fluorine-containing antifouling agent (A) is 1% by weight or more and less than 25% by weight based on a total solid content of the coating composition:

(Rf)-[(W)-(R_{A})ₙ]ₘ Formula (F)

In formula (F), Rf represents a (per)fluoroalkyl group or a (per)fluoropolyether group, W represents a connecting group, R_{A} represents a functional group having a polymerizable unsaturated group, n represents an integer of 1 to 3, and m represents an integer of 1 to 3.
(2) The antireflective film as described in (1) above, which has a surface energy of less than 16 mN/m.
(3) The antireflective film as described in (1) or (2) above, which has surface roughness determined by an atomic force microscope of less than 5 nm.
(4) The antireflective film as described in any one of (1) to (3) above, wherein the inorganic fine particle (C) is a silica fine particle having a hollow structure.
(5) The antireflective film as described in any one of (1) to (4) above, wherein an average particle size of the inorganic fine particle (C) is 15 nm or more and less than 100 nm.
(6) The antireflective film as described in any one of (1) to (5) above, wherein a content of the inorganic fine particle (C) is 30 by weight or more based on a total solid content of the coating composition.
(7) The antireflective film as described in any one of (1) to (6) above, which further has a high refractive index layer on the transparent substrate film.
(8) The antireflective film as described in any one of (1) to (7) above, which further has a medium refractive index layer and a high refractive index layer on the transparent substrate film, wherein the medium refractive index layer, the high refractive index layer and the low refractive index layer are provided in this order from a side of the transparent substrate film.
(9) The antireflective film as described in any one of (1) to (8) above, wherein at least one of the medium refractive index layer and the high refractive index layer contains a conductive inorganic fine particle.
(10) The antireflective film as described in (9) above, wherein the conductive inorganic fine particle contained in at least one of the medium refractive index layer and the high refractive index layer contains one or more metal oxides selected from the group consisting of tin-doped indium oxide (ITO), antimony-doped tin oxide (ATO), fluorine-doped tin oxide (PTO), phosphorous-doped tin oxide (PTO), zinc antimonite (AZO), indium-doped zinc oxide (IZO), zinc oxide, ruthenium oxide, rhenium oxide, silver oxide, nickel oxide and copper oxide.
(11) The antireflective film as described in any one of (8) to (10) above, wherein tint of regular reflecting light for incident light at an angle of 5 degree of a CIE standard light source D65 in a wavelength range from 380 to 780 nm satisfies following conditions that a* value and b* value in CIE1976 L*a*b* color space are in ranges of 0≦a*≦8 and −10≦b*≦0, respectively, and within the tint variation range, a color difference ΔE due to 2.5% fluctuation in a thickness of at least one layer contained in the antireflective film falls in a range of equation (5) shown below:

ΔE={(L*−L*′)²+(a*−a*′)²+(b*−b*′)²}^{1/2}≦3 Equation (5)

wherein L*′, a*′, and b*′ indicate tint of reflected light at a designed film thickness.
(12) The antireflective film as described in any one of (1) to (11) above, which further has a hardcoat layer on the transparent substrate film.
(13) The antireflective film as described in (12) above, wherein the hardcoat layer contains a conductive compound.
(14) A polarizing plate comprising a polarizing film and two protective films for the polarizing film, wherein at least one of the two protective films is the antireflective film as described in any of (1) to (13) above.
(15) An image display device wherein the antireflective film as described in any of (1) to (13) above or the polarizing plate as described in (14) above is provided at an outermost surface of the display.
(16) A coating composition for forming a low refractive index layer containing at least (A) a fluorine-containing antifouling agent having a weight average molecular weight (Mw) of less than 10,000, a polymerizable unsaturated group and a structure represented by formula (F) shown below, (B) a polyfunctional monomer having a polymerizable unsaturated group and (C) an inorganic fine particle, and a content of the fluorine-containing antifouling agent (A) is 1% by weight or more and less than 25% by weight based on a total solid content of the coating composition and components other than the fluorine-containing antifouling agent (A) do not contain a fluorine atom:

(Rf)-[(W)-(R_{A})ₙ]ₘ Formula (F)

In formula (F), Rf represents a (per)fluoroalkyl group or a (per)fluoropolyether group, W represents a connecting group, R_{A} represents a functional group having a polymerizable unsaturated group, n represents an integer of 1 to 3, and m represents an integer of 1 to 3.

The antireflective film having a low refractive index layer formed from a coating composition for forming a low refractive index layer contains a fluorine-containing antifouling agent having a weight average molecular weight (Mw) of less than 10,000 and a polymerizable unsaturated group in addition to a polyfunctional monomer having a polymerizable unsaturated group and an inorganic fine particle according to the present invention has an effect of preventing attachment of a fat or oil component, for example, a fingerprint or sebum and of easily wiping off the fat or oil component, even if it is attached, while maintaining the low reflectivity and scratch resistance.

Further, by adjusting the content of the fluorine-containing antifouling agent to 1% by weight or more and less than 25% by weight, the transfer of the fluorine-containing antifouling agent at the preservation in the form of roll is prevented and, even if it is transferred, the fluorine-containing antifouling agent transferred can be limited to a small amount. Thus, it is possible to conduct continuous production and the remarkable effect is achieved in the improvement of production efficiency.

Moreover, it is possible to use a multi-layer type antireflective film in order to further reduce the reflectivity, but in a hitherto known construction, when a fingerprint or sebum is attached on the surface of a coated film, even if it is wiped off, some residue of the fat or oil component, if any, remains, and thus, it is noticeable because the attachment trace is more readily recognized as the change in the tint based on the change in the refractive index in comparison with the one-layer type antireflective film, thereby reducing the visibility of the image. So, in response, by constructing the antireflective film to have a medium refractive index layer, a high refractive index layer and a low refractive index layer laminated (stacked) on a transparent substrate film in this order from the side of the transparent substrate film and controlling tint of regular reflecting light for incident light at an angle of 5 degree of a CIE standard light source D65 in a wavelength range from 380 to 780 nm to satisfy the following conditions that a* value and b* value in CIE1976 L*a*b* color space are in ranges of 0≦a*≦8 and −10≦b*≦0, respectively, an antireflective film, wherein in spite of the multi-layer type, the reflection color is neutral and a fingerprint or sebum, if attached on the surface of a coated film, is easily wiped off and is hardly noticeable, can be obtained.

Furthermore, by incorporating a conductive inorganic fine particle into the medium refractive index layer or the high refractive index layer, an antireflective film, wherein in spite of using the fluorine-containing antifouling agent, property of dust attachment property is good without accompanying degradation of the antistatic property, can be obtained.

### DETAILED DESCRIPTION OF THE INVENTION

The present invention will be described in more detail below. In the specification, the terms “(meth)acrylate”, “(meth)acrylic acid” and “(meth)acryloyl” as used herein mean “acrylate or methacrylate”, “acrylic acid or methacrylic acid” and “acryloyl or methacryloyl”, respectively.

The antireflective film according to the invention is characterized by comprising a transparent substrate film and at least one low refractive index layer, wherein the low refractive index layer is formed from a coating composition containing at least (A) a fluorine-containing antifouling agent having a weight average molecular weight (Mw) of less than 10,000, a polymerizable unsaturated group and a structure represented by formula (F) shown below, (B) a polyfunctional monomer having a polymerizable unsaturated group and (C) an inorganic fine particle, and a content of the fluorine-containing antifouling agent (A) is 1% by weight or more and less than 25% by weight based on a total solid content of the coating composition:

(Rf)-[(W)-(R_{A})ₙ]ₘ Formula (F)

In formula (F), Rf represents a (per)fluoroalkyl group or a (per)fluoropolyether group, W represents a connecting group, R_{A} represents a functional group having a polymerizable unsaturated group, n represents an integer of 1 to 3, and m represents an integer of 1 to 3.

Also, the coating composition for forming a low refractive index layer according to the invention is characterized by containing at least (A) a fluorine-containing antifouling agent having a weight average molecular weight (Mw) of less than 10,000, a polymerizable unsaturated group and a structure represented by formula (F) shown below, (B) a polyfunctional monomer having a polymerizable unsaturated group and (C) an inorganic fine particle, and a content of the fluorine-containing antifouling agent (A) is 1% by weight or more and less than 25% by weight based on a total solid content of the coating composition, wherein components other than the fluorine-containing antifouling agent (A) do not contain a fluorine atom:

(Rf)-[(W)-(R_{A})ₙ]ₘ Formula (F)

In formula (F), Rf represents a (per)fluoroalkyl group or a (per)fluoropolyether group, W represents a connecting group, R_{A} represents a functional group having a polymerizable unsaturated group, n represents an integer of 1 to 3, and m represents an integer of 1 to 3.

### (A) Fluorine-Containing Antifouling Agent

The coating composition for forming a low refractive index layer according to the invention contains a fluorine-containing antifouling agent as the essential component for the purpose of imparting a property, for example, an antifouling property, water resistance, chemical resistance or a slipping property.

### [Structure of Fluorine-Containing Antifouling Agent]

The fluorine-containing antifouling agent according to the invention is a fluorine-based compound having a structure represented by formula (F) shown below.

(Rf)-[(W)-(R_{A})ₙ]ₘ Formula (F)

In formula (F), Rf represents a (per)fluoroalkyl group or a (per)fluoropolyether group, W represents a connecting group, R_{A} represents a functional group having a polymerizable unsaturated group, n represents an integer of 1 to 3, and m represents an integer of 1 to 3.

The fluorine-containing antifouling agent has a polymerizable unsaturated group, whereby inhibition of the transfer of the fluorine-containing compound to the rare surface when the coating composition for forming a low refractive index layer is coated and preserved in the form of roll, improvement in the scratch resistance of the coated film and improvement in the durability against repeated wipe off of stain can be achieved. Although it has been hitherto known to use a silicone compound having a dimethylsiloxane structure in order to exhibit the antifouling property, the use of the fluorine-containing antifouling agent may provide a more excellent antifouling property in some cases.

In formula (F) R_{A} represents a functional group having a polymerizable unsaturated group. The polymerizable unsaturated group is not particularly limited as far as it is a group capable of initiating a radical polymerization reaction upon irradiation of an active energy ray, for example, an ultraviolet ray or an electron beam, and a (meth)acryloyl group or a (meth)acryloyloxy group is preferably used.

In formula (F), Rf represents a (per)fluoroalkyl group or a (per)fluoropolyether group.

The term “(per)fluoroalkyl group” as used herein means at least one of a fluoroalkyl group and a perfluoroalkyl group and the term “(per)fluoropolyether group” means at least one of a fluoropolyether group and a perfluopolyether group. From the standpoint of the antifouling property, it is preferred that the content rate of fluorine in Rf is high.

The (per)fluoroalkyl group is preferably that having from 1 to 20 carbon atoms, and more preferably that having from 1 to 10 carbon atoms.

The (per)fluoroalkyl group may have a straight-chain structure (for example, —CF₂CF₃, —CH₂(CF₂)₄H, —CH₂(CF₂)₈CF₃ or —CH₂CH₂(CF₂)₄H), a branched structure (for example, —CH(CF₃)₂, —CH₂CF(CF₃)₂, —CH(CH₃)CF₂CF₃ or —CH(CH₃)(CF₂)₅CF₂H) or an alicyclic structure (preferably, a 5-membered or 6-membered ring structure, for example, a perfluorocyclohexyl group, a perfluorocyclopentyl group or an alkyl group substituted with each of these groups).

A plurality of the (per)fluoroalkyl groups may be contained in the same molecule.

The (per)fluoropolyether group represents a (per)fluoroalkyl group including an ether bond. The fluoropolyether group includes, for example, —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H and a fluorocycloalkyl group having 4 or more fluorine atoms and from 4 to 20 carbon atoms. The perfluoropolyether group includes, for example, —(CF₂)ₚO(CF₂CF₂O)_{q}, —[CF(CH₃)CF₂O]ₚ—[CF₂(CF₃)]], —(CF₂CF₂CF₂O)ₚ and —(CF₂CF₂O)ₚ. The total number of p and q is preferably from 1 to 83, more preferably from 1 to 43, and most preferably from 5 to 23.

In formula (F), W represents a connecting group. W includes, for example, an alkylene group, an arylene group, a heteroalkylene group and a connecting group formed by combination thereof. The connecting group may further have a functional group, for example, a carbonyl group, a carbonyloxy group, a carbonylimino group, a sulfonamide group or a functional group formed by combination thereof.

W is preferably an ethylene group, and more preferably an ethylene group combined with a carbonylimino group.

The fluorine-based compound may be any one of a monomer, an oligomer and a polymer.

It is preferred that the fluorine-based compound has a substituent which contributes bond formation or compatibility in low refractive index layer film. The substituents are preferably present two or more and may be the same or different from each other. Examples of the preferable substituent include an acryloyl group, a methacryloyl group, a vinyl group, an allyl group, a cinnamoyl group, an epoxy group, an oxethanyl group, a hydroxyl group, a polyoxyalkylene group, a carboxyl group and an amino group.

The fluorine-based compound may be a polymer or oligomer and a polymer with a compound which does not contain a fluorine atom.

The fluorine atom content in the fluorine-based compound is not particularly limited and is preferably 20% by weight or more, particularly preferably from 30 to 70% by weight, and most preferably from 40 to 70% by weight.

Examples of the preferable fluorine-based compound include R-2020, M-2020, R-3833, M-3833 and Optool DAC (all trade names, produced by Daikin Industries, Ltd. and Megafac F-171, Megafac F-172 and Megafac F-179A and Defensa MCF-300 and Defensa MCF-323 (all trade names, produced by Dainippon Ink & Chemicals, Inc.), but the invention should not be construed as being limited thereto.

In formula (F), the total number of n and m is preferably 2 or more.

In the case where both n and m represent 1 in formula (F), compounds represented by formulae (F-1) to (F-3) shown below are examples of a preferable embodiment.

Rf²(CF₂CF₂)ₚCH₂CH₂R²OCOCR¹═CH₂ Formula (F-1)

In formula (F-1), Rf² represents a fluorine atom or a fluoroalkyl group having from 1 to 10 carbon atoms, R¹ represents a hydrogen atom or a methyl group, R² represents a single bond or an alkylene group, p represents an integer indicating a polymerization degree, and the polymerization degree p is not less than k (in which k represents an integer of 3 or more).

Examples of the telomeric acrylate containing a fluorine atom in formula (F-1) include partially or fully fluorinated alkyl ester derivatives of (meth)acrylic acid.

Specific examples of the compound represented by formula (F-1) are set forth below, but the invention should not be construed as being limited thereto.

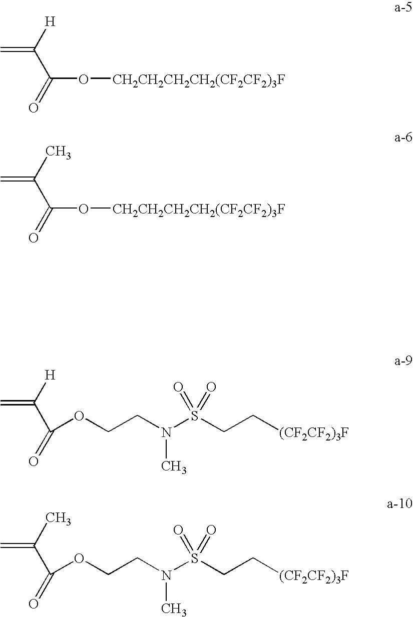

The compound represented by formula (F-1) may comprise a plurality of fluorine-containing (meth)acrylates in which p in the group, Rf²(CF₂CF₂)ₚCH₂CH₂R²O—, of formula (F-1) is each k, k+1, k+2, . . . , or the like, according to telomerization condition, separation condition of a reaction mixture or the like, in the case of using the telomerization in the synthesis thereof.

F(CF₂)_{q}—CH₂—CHX—CH₂Y Formula (F-2)

In formula (F-2), q represents an integer of 1 to 20, and X and Y are either a (meth)acryloyloxy group or a hydroxyl group, provided that at least one of X and Y represents a (meth)acryloyloxy group.

The fluorine-containing (meth)acrylate represented by formula (F-2) has a fluoroalkyl group having from 1 to 20 carbon atoms which has a trifluoromethyl group (CF₃—) at its terminal, and as for the fluorine-containing (meth)acrylate, the trifluoromethyl group is effectively oriented on the surface even in the case of using a small amount thereof.

From the standpoint of antifouling property and ease of production, q is preferably from 6 to 20, and more preferably from 8 to 10. The fluorine-containing (meth)acrylate having a fluoroalkyl group having from 8 to 10 carbon atoms is excellent in the antifouling property since it exhibits excellent water/oil repellency, in comparison with a fluorine-containing (meth)acrylates having a fluoroalkyl group of other chain-length.

Specific examples of the fluorine-containing (meth)acrylate represented by formula (F-2) include 1-(meth)acryloyloxy-2-hydroxy-4,4,5,5,6,6,7,7,8,8,9,9,10,10,11,11,12,12,13,13,13-heneicosafluorotridecane, 2-(meth)acryloyloxy-1-hydroxy-4,4,5,5,6,6,7,7,8,8,9,9,10,10,11,11,12,12,13,13,13-heneicosafluorotridecane and 1,2-bis(meth)acryloyloxy-4,4,5,5,6,6,7,7,8,8,9,9,10,10,11,11,12,12,13,13,13-heneicosafluorotridecane. In the invention, 1-acryloyloxy-2-hydroxy-4,4,5,5,6,6,7,7,8,8,9,9,10,10,11,11,12,12,13,13,13-heneicosafluorotridecane is preferable.

F(CF₂)ᵣO(CF₂CF₂O)ₛCF₂CH₂OCOCR³═CH₂ Formula (F-3)

In formula (F-3), R³ represents a hydrogen atom or a methyl group, s represents an integer of 1 to 20, and r represents an integer of 1 to 4.

The fluorine atom-containing monofunctional (meth)acrylate represented by formula (F-3) can be obtained by reacting a fluorine atom-containing alcohol compound represented by formula (FG-3) shown below with a (meth)acrylic acid halide:

F(CF₂)ᵣO(CF₂CF₂O)ₛCF₂CH₂OH Formula (FG-3)

In formula (FG-3), s represents an integer of 1 to 20 and r represents an integer of 1 to 4.

Specific examples of the fluorine atom-containing alcohol compound represented by formula (FG-3) include 1H,1H-perfluoro-3,6-dioxaheptan-1-ol, 1H,1H-perfluoro-3,6-dioxaoctan-1-ol, 1H,1H-perfluoro-3,6-dioxadecan-1-ol, 1H,1H-perfluoro-3,6,9-trioxadecan-1-ol, 1H,1H-perfluoro-3,6,9-trioxaundecan-1-ol, 1H,1H-perfluoro-3,6,9-trioxamidecan-1-ol, 1H,1H-perfluoro-3,6,9,12-tetraoxamidecan-1-ol, 1H,1H-perfluoro-3,6,9,12-tetraoxatetradecan-1-ol, 1H,1H-perfluoro-3,6,9,12-tetraoxahexadecan-1-ol, 1H,1H-perfluoro-3,6,9,12,15-pentaoxahexadecan-1-ol, 1H,1H-perfluoro-3,6,9,12,15-pentaoxaheptadecan-1-ol, 1H,1H-perfluoro-3,6,9,12,15-pentaoxanonadecan-1-ol, 1H,1H-perfluoro-3,6,9,12,15,18-hexaoxaeicosan-1-ol, 1H,1H-perfluoro-3,6,9,12,15,18-hexaoxadocosan-1-ol, 1H,1H-perfluoro-3,6,9,12,15,18,21-heptaoxatricosan-1-ol, and 1H,1H-perfluoro-3,6,9,12,15,18,21-heptaoxapentacosan-1-ol.

These compounds are commercially available, and specific examples thereof include, 1H,1H-perfluoro-3,6-dioxaheptan-1-ol: trade name: C5GOL, produced by Exfluor Research Corp., 1H,1H-perfluoro-3,6,9-trioxadecan-1-ol: trade name: C7GOL, produced by Exfluor Research Corp., 1H,1H-perfluoro-3,6-dioxadecan-1-ol: trade name: C8GOL: produced by Exfluor Research Corp., 1H,1H-perfluoro-3,6,9-trioxamidecan-1-ol: trade name: C10GOL: produced by Exfluor Research Corp., 1H,1H-perfluoro-3,6,9,12-tetraoxahexadecan-1-ol: trade name: C12GOL: produced by Exfluor Research Corp.

In the invention, 1H,1H-perfluoro-3,6,9,12-tetraoxamidecan-1-ol is preferably used.

Examples of the (meth)acrylic acid halide to be reacted with the fluorine atom-containing alcohol compound represented by formula (FG-3) include (meth)acrylic acid fluoride, (meth)acryl acid chloride, (meth)acrylic acid bromide and (meth)acrylic acid iodide, and (meth)acrylic acid chloride is preferred from the standpoint of easy availability:

Preferable specific examples of the compound represented by formula (F-3) are set forth below, but the invention should not be construed as being limited thereto. Preferable specific examples of the compound represented by formula (F-3) are also described in JP-A-2007-264221.

(b-1): F₉C₄OC₂F₄OC₂F₄OCF₂CH₂OCOCH═CH₂
(b-2): F₉C₄OC₂F₄OC₂F₄OCF₂CH₂OCOC(CH₃)═CH₂

Moreover, separately from the compound represented by formula (F-3), a fluorine-containing unsaturated compound represented by formula (F-3)' shown below can also be preferably used.

Rf³-[(O)_{c}(O═C)_{b}(CX⁴X⁵)ₐ—CX³═CX¹X²] Formula (F-3)′

In formula (F-3)', X¹ and X² each independently represents H or F, X³ represents H, F, CH₃ or CF₃, X⁴ and X⁵ each independently represents H, F or CF₃, a, b, and c each independently represents 0 or 1, Rf³ represents a fluorine-containing alkyl group which contains an ether bond, has 18 to 200 carbon atoms and includes 6 or more repeating units represented by formula (FG-3)′ shown below:

—(CX⁶₂CF₂CF₂O)— Formula (FG-3)'

In formula (FG-3)', X⁶ represents F or H.

Examples of the fluorine-containing polyether compound represented by formula (F-3)' include:

(c-1): Rf³-[(O)(O═C)_{b}—CX³═CX¹X²]
(c-2): Rf³-[(O)(O═C)—CX³═CX¹X²]
(c-3): Rf³-[(O)_{c}(O═C)—CF═CH₂]

As the polymerizable unsaturated group in the fluorine-containing polyether compound, groups containing the structure shown below are preferably used.

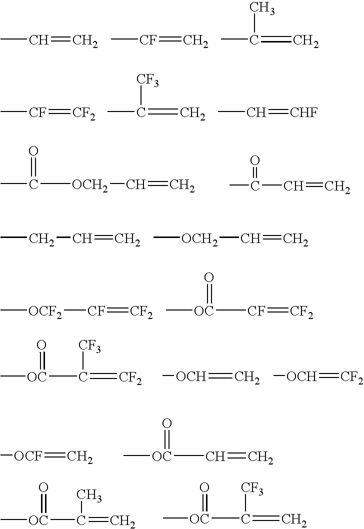

The fluorine-containing polyether compound represented by formula (F-3)′ may have a plurality of the polymerizable unsaturated groups. The structures shown below are preferably exemplified.

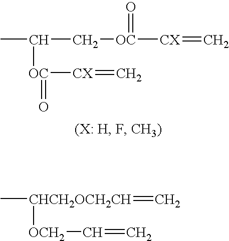

In the invention, the fluorine-containing polyether compound having a structure of —O(C═O)CF═CH₂ is preferable since the polymerization (curing) reactivity is particularly high so that a cured compound can be efficiently obtained.

As for the Rf³ group in the fluorine-containing polyether compound represented by formula (F-3)′, it is important that the Rf³ group contains 6 or more repeating units of the fluorine-containing polyether chain of formula (FG-3)′, whereby the antifouling property can be imparted.

More specifically, when the compound is used as a structure unit of a specific fluorine-containing polymer, a photopolymerizable composition and a coating composition described hereinafter, although a mixture containing the compound having 6 or more repeating units of the fluorine-containing polyether chain may be used, in the case of using the form of a mixture, the mixture in which in the distribution of the fluorine-containing unsaturated compound having less than 6 repeating units and the fluorine-containing unsaturated compound having 6 or more repeating units, the present ratio of the fluorine-containing unsaturated compound having 6 or more repeating units of the polyether chain is highest is preferable.

A number of the repeating units of the fluorine-containing polyether chain of formula (FG-3)′ is preferably 6 or more, more preferably 10 or more, still more preferably 18 or more, and particularly preferably 20 or more. Thus, the antifouling property, particularly the property of removing stain including a fat or oil component as well as water repellency can be improved. Also, a gas permeation property can be more effectively imparted. The fluorine-containing polyether chain may be present at the terminal of the Rf³ group or in the chain of the Rf³ group.

Specifically, the Rf³ group preferably has a structure represented by formula (c-4) shown below.

R⁴—(CX⁶₂CF₂CF₂O)ₜ—(R⁵)ₑ— Formula (c-4)

In formula (c-4), X⁶ has the same meaning as defined in formula (FG-3)′, R⁴ represents at least one selected from a hydrogen atom, a halogen atom, an alkyl group, a fluorine-containing alkyl group, an alkyl group containing an ether bond and a fluorine-containing alkyl group containing an ether bond, R⁵ represents a divalent or higher valent organic group, t represents an integer of 6 to 66, and e represents 0 or 1.

That is, the Rf³ group is a fluorine-containing organic group which is connected to a reactive carbon-carbon double bond through the divalent or higher valent organic group represented by R⁵ and has R⁴ at the terminal.

R⁵ may be any organic group capable of connecting the fluorine-containing polyether chain of formula (FG-3)′ to the reactive carbon-carbon double bond and is selected, for example, from an alkylene group, a fluorine-containing alkylene group, an alkylene group containing an ether bond and a fluorine-containing alkylene group containing an ether bond. Among them, a fluorine-containing alkylene group or a fluorine-containing alkylene group containing an ether bond is preferable from the standpoint of transparency and low refractivity.

As specific examples of the fluorine-containing polyether compound represented by formula (F-3)′, compounds described in WO 2003/022906 are preferably used. In the invention, CH₂═CF—COO—CH₂CF₂CF₂—(OCF₂CF₂CF₂)₂₀—OC₈F₁₇ can be particularly preferably used.

In the case where n and m are not 1 at the same time in formula (F), compounds represented by formulae (F-4) and (F-5) shown below are examples of a preferable embodiment.

(Rf¹)—[(W)-(R_{A})ₙ]ₘ Formula (F-4)

In formula (F-4), Rf¹ represents a (per)fluoroalkyl group or a (per)fluoropolyether group, W represents a connecting group, and R_{A} represents a functional group having an unsaturated double bond, n represents an integer of 1 to 3, and m represents an integer of 1 to 3, provided that n and m are not 1 at the same time.

From the standpoint of excellent water/oil repellency and excellent enduring water/oil repellency (antifouling durability), it is preferred that n represents 2 or 3 and m represents 1 to 3. It is more preferred that n represents 2 or 3 and m represents 2 or 3. It is most preferred that n represents 3 and m represents 2 or 1

The group represented by Rf¹ is any one of a monovalent group to a trivalent group. In the case where Rf¹ is a monovalent group, the terminal group is preferably (CₙF₂ₙ₊₁)—, (CₙF₂ₙ₊₁O)—, (XCₙF₂ₙO)— or (XCₙF₂ₙ₊₁)— (wherein X is a hydrogen atom, a chlorine atom or a bromine atom, and n is an integer of 1 to 10). Specifically, for example, CF₃O(C₂F₄O)ₚCF₂—, C₃F₇O(CF₂CF₂CF₂O)ₚCF₂CF₂—, C₃F₇O(CF(CF₃)CF₂O)ₚCF(CF₃)— and F(CF(CF₃)CF₂O)ₚCF(CF₃)— can be preferably used.

In the above formulae, p represents an average number from 0 to 50, preferably from 3 to 30, more preferably from 3 to 20, and most preferably from 4 to 15.

In the case where Rf¹ is a divalent group, for example, —(CF₂O)_{q}(C₂F₄O)ᵣCF₂—, —(CF₂)₃O(C₄F₈O)ᵣ(CF₂)₃—, —CF₂O(C₂F₄O)ᵣCF₂—, —C₂F₄O(C₃F₆O)ᵣC₂F₄— and —CF(CF₃)(OCF₂CF(CF₃))ₛOCₜF₂ₜO(CF(CF₃)CF₂O)ᵣCF(CF₃)— can be preferably used.

In the above formulae, average values of q, r and s each represents from 0 to 50, preferably from 3 to 30, more preferably from 3 to 20, and most preferably from 4 to 15. t represents an integer of 2 to 6.

Preferable specific examples and synthesis methods of the compound represented by formula (F-4) are described in WO 2005/113690.

Specific examples of the compound represented by formula (F-4) are set forth below, but the invention should not be construed as being limited thereto. In the specific examples below, “HFPO—” represents a group of F(CF(CF₃)CF₂O)ₚCF(CF₃)— wherein p represents an average number from 6 to 7.

(d-1): HFPO—CONH—C—(CH₂OCOCH═CH₂)₂CH₂CH₃
(d-2): HFPO—CONH—C—(CH₂OCOCH═CH₂)₂H
(d-3): Michael addition polymerization product of HFPO—CONH—C₃H₆NHCH₃ and trimethylolpropane triacrylate (1:1)
(d-4): (CH₂═CHCOOCH₂)₂H—C—CONH—HFPO—CONH—C—(CH₂OCOCH═CH₂)₂H
(d-5): (CH₂═CHCOOCH₂)₃—C—CONH—HFPO—CONH—C—(CH₂OCOCH═CH₂)₃

Further, a compound represented by formula (F-5) is used as a compound represented by formula (F-4).

CH₂═CX₁—COO—CHY—CH₂—OCO—CX₂═CH₂ Formula (F-5)

In formula (F-5), X₁ and X₂ each independently represents a hydrogen atom or a methyl group, and Y represents a fluoroalkyl group having from 2 to 20 carbon atoms and containing 3 or more fluorine atoms or a fluorocycloalkyl group having from 4 to 20 carbon atoms and containing 4 or more fluorine atoms.

In the invention, the compound having a (meth)acryloyloxy group as the polymerizable unsaturated group may have a plurality of (meth)acryloyloxy groups. By using the fluorine containing antifouling agent having a plurality of (meth)acryloyloxy groups, a three-dimensional network structure is formed upon curing whereby a high glass transition temperature, a low transfer property of the antifouling agent and improvement in the durability against repeated wiping off of stain can be achieved. Further, a cured film excellent in heat resistance, weather resistance and the like can be obtained.

Specific examples of the compound represented by formula (F-5) preferably include di(meth)acrylic acid-2,2,2-trifluoroethyl ethylene glycol, di(meth)acrylic acid-2,2,3,3,3-pentafluoropropyl ethylene glycol, di(meth)acrylic acid-2,2,3,3,4,4,4-heptafluorobutyl ethylene glycol, di(meth)acrylic acid-2,2,3,3,4,4,5,5,5-nonafluoropentyl ethylene glycol, di(meth)acrylic acid-2,2,3,3,4,4,5,5,6,6,6-undecafluorohexyl ethylene glycol, di(meth)acrylic acid-2,2,3,3,4,4,5,5,6,6,7,7,7-tridecafluoroheptyl ethylene glycol, di(meth)acrylic acid-2,2,3,3,4,4,5,5,6,6,7,7,8,8,8-pentadecafluorooctyl ethylene glycol, di(meth)acrylic acid-3,3,4,4,5,5,6,6,7,7,8,8,8-tridecafluorooctyl ethylene glycol, di(meth)acrylic acid-2,2,3,3,4,4,5,5,6,6,7,7,8,8,9,9,9-heptadecafluorononyl ethylene glycol, di(meth)acrylic acid-2,2,3,3,4,4,5,5,6,6,7,7,8,8,9,9,10,10,10-nonadecafluorodecylethylene glycol, di(meth)acrylic acid-3,3,4,4,5,5,6,6,7,7,8,8,9,9,10,10,10-heptadecafluorodecylethylene glycol, di(meth)acrylic acid-2-trifluoromethyl-3,3,3-trifluoropropyl ethylene glycol, di(meth)acrylic acid-3-trifluoromethyl-4,4,4-trifluorobutyl ethylene glycol, di(meth)acrylic acid-1-methyl-2,2,3,3,3-pentafluoropropyl ethylene glycol, di(meth)acrylic acid-1-methyl-2,2,3,3,4,4,4-heptafluorobutyl ethylene glycol. These compounds may be used individually or as a mixture. In order to prepare such a di(meth)acrylic acid ester, a known method as described in JP-A-6-306326 can be used. In the invention, diacrylic acid-2,2,3,3,4,4,5,5,6,6,7,7,8,8,9,9,9-heptadecafluorononyl ethylene glycol is preferably used.

In the invention, according to a preferred second embodiment of the compound having a (meth)acryloyloxy group as the polymerizable unsaturated group, a compound having a plurality of (per)fluoroalkyl group or (per)fluoropolyether group in its molecule is exemplified.

Further, the compound having a (meth)acryloyloxy group as the polymerizable unsaturated group may be a siloxane compound. By using the fluorine-containing antifouling agent having a siloxane skeleton, the antifouling agent is likely to cause maldistribution on the surface so that the upper surface on the substrate after the curing exhibits the excellent water/oil repellency, resulting in achieving the excellent antifouling property. In addition, the scratch resistance can be imparted.

As a preferred embodiment, a fluorine-containing (meth)acrylate compound represented by formula (F-6) shown below will be described below.

RₐR^{f}_{b}R^{A}_{c}SiO_{(4-a-b-c)/2} Formula (F-6)

In formula (F-6) R represents a hydrogen atom, a methyl group, an ethyl group, a propyl group or a phenyl group, R^{f} represents an organic group containing a fluorine atom, R^{A} represents an organic group containing a (meth)acryl group, and a+b+c<4.

a represents from 1 to 1.75, and preferably from 1 to 1.5. When a is less than 1, synthesis of the compound is industrially difficult, whereas when a is more than 1.75, compatibility between the curing property and the antifouling property cannot be attained.

le represents an organic group containing a fluorine atom and is preferably a group represented by CₓF₂ₓ₊₁(CH₂)ₚ— (wherein x represents an integer of 1 to 8, and p represents an integer of 2 to 10) or a perfluoropolyether-substituted alkyl group. b represents from 0.2 to 0.4, and preferably from 0.2 to 0.25. When b is less than 0.2, the antifouling property is reduced, whereas when b is more than 0.4, the curing property is deteriorated.

R^{A} represents an organic group containing a (meth)acryl group and from the standpoint of ease of industrial synthesis, it is more preferred that its bond to the Si atom is a Si—O—C bond. c represents from 0.4 to 0.8, and preferably from 0.6 to 0.8. When c is less than 0.4, the curing property is deteriorated, whereas when c is more than 0.8, the antifouling property is reduced.

a+b+c is preferably from 2 to 2.7, and more preferably from 2 to 2.5. When a+b+c is less than 2, the maldistribution of the compound on the surface hardly occur, whereas when a+b+c is more than 2.7, compatibility between the curing property and the antifouling property cannot be attained.

The polyfunctional acrylate according to the invention contains 3 or more F atoms and 3 or more Si atoms, and preferably 3 to 17 F atoms and 3 to 8 Si atoms in its molecule. When it contains less than 3 F atoms, the antifouling property is insufficient, whereas when it contains less than 3 Si atoms, due to failure of the maldistribution of the compound on the surface, the antifouling property is insufficient.

The polyfunctional (meth)acrylate compound can be produced by a known method, for example, a method described in JP-A-2007-145884.

The siloxane structure may have any of straight-chain, branched and cyclic structures. Among them, the branched and cyclic structures are preferred because of good compatibility with, for example, other polyfunctional (meth)acrylate described hereinafter, no repelling and ease of occurrence of the maldistribution of the compound on the surface.

As the polyfunctional (meth)acrylate compound in which the siloxane structure is a branched structure, a compound represented by the formula shown below is preferred.

R^{f}SiRₖ[OSiRₘ(OR^{A})₃₋ₘ]₃₋ₖ

In the above formula, R, R^{f}, and R^{A} have the same meanings as defined above, respectively, m represents 0, 1 or 2, particularly m represents 2, and k represents 0 or 1.

As the polyfunctional (meth)acrylate compound in which the siloxane structure is a cyclic structure, a compound represented by the formula shown below is preferred.

(R^{f}RSiO)(R^{A}RSiO)ₙ

In the above formula, R, R^{f} and R^{A} have the same meanings as defined above, respectively, and n≧2, particularly 3≦n≦5).

Specific examples of the polyfunctional (meth)acrylate compound include the compounds shown below.

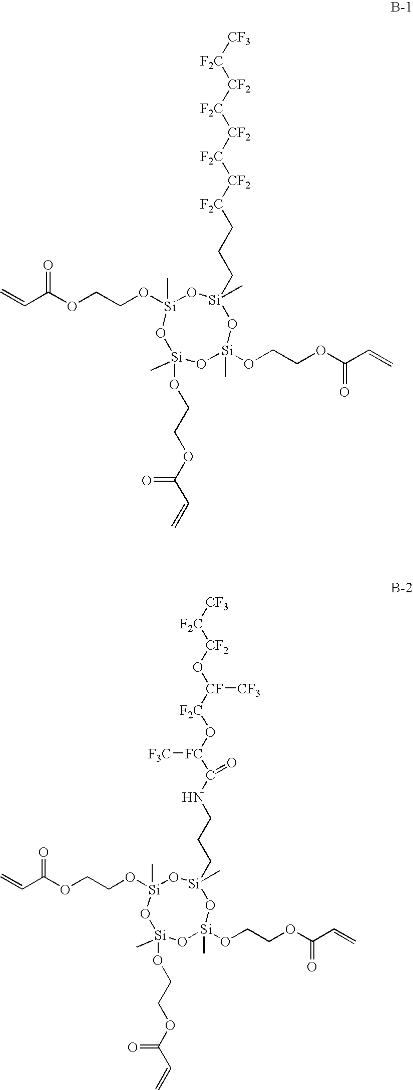

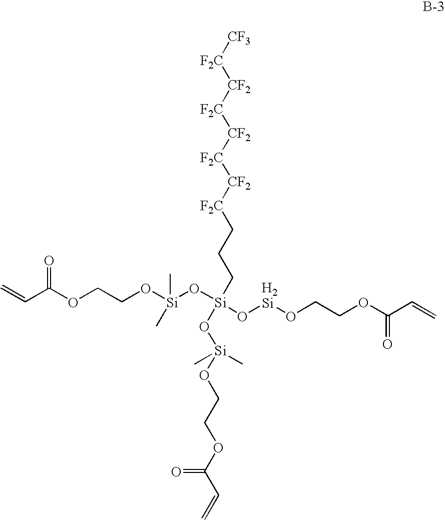

In the invention, R^{f} is preferably a perfluoroalkyl group having 8 carbon atoms.

### [Molecular Weight of Fluorine-Containing Antifouling Agent]

A weight average molecular weight (Mw) of the fluorine-containing antifouling agent having a polymerizable unsaturated group can be measured by using molecular exclusion chromatography, for example, gel permeation chromatography (GPC). The Mw of the fluorine-containing antifouling agent for use in the invention is less than 10,000. It is preferably from 400 to 5,500, more preferably from 800 to 4,500, and most preferably from 1,000 to 3,500. When the Mw of the antifouling agent is less than 400, the surface migration property of the antifouling agent is low, whereas when the Mw of the antifouling agent is 10,000 or more, the surface migration of the antifouling agent is inhibited from a coating step to a curing step. Thus, the antifouling agent is not uniformly oriented at the outermost surface of the layer and also distributed inside the layer and as a result, the film strength decreases, resulting in reduction of the scratch resistance. Also, when the Mw of the antifouling agent is 10,000 or more, the compatibility with other ingredients degrades to form a sea-island structure, thereby deteriorating the antifouling property. As for the distribution state of the antifouling agent in the thickness direction in the low refractive index layer, it is preferred to satisfy 201%<X/Y<401%, wherein X represents a fluorine content at the outermost surface of the low refractive index layer and Y represents a whole fluorine content in the low refractive index layer. When the X/Y is larger than 201%, the antifouling agent is not distributed inside the low refractive index layer, which is preferable in view of the scratch resistance. When the X/Y is smaller than 401%, the antifouling agent does not deposit on the surface to prevent whitening of the layer or generation of white powder on the surface, which is thus preferable.

### [Amount of Fluorine-Containing Antifouling Agent]

An amount of the fluorine-containing antifouling agent having a polymerizable unsaturated group added to the coating composition is 1% by weight or more and less than 25% by weight based on the total solid content of the coating composition. The amount is preferably 1% by weight or more and less than 20% by weight, more preferably 1% by weight or more and less than 15% by weight, and most preferably 1% by weight or more and less than 10% by weight. When the amount is less than 1% by weight, the antifouling property can not be sufficiently obtained, because a ratio of the antifouling agent having a water/oil repellency is too low. When the amount is more than 25% by weight, the antifouling agent which is not mixed with a binder component deposits on the surface to cause whitening of the layer or generation of white powder on the surface, which is thus not preferable.

(B) Polyfunctional Monomer having Polymerizable Unsaturated Group

The coating composition for forming a low refractive index layer according to the invention contains a polyfunctional monomer having a polymerizable unsaturated group as the component for forming a binder of the low refractive index layer. The polyfunctional monomer having a polymerizable unsaturated group is preferred, because a combinational effect on improvement in the scratch resistance is large particularly when a compound having a polymerizable unsaturated group in a polymer main body is used together.

It is preferred that the polyfunctional monomer having a polymerizable unsaturated group does not contain a fluorine atom. It is believed that in the case of using the polyfunctional monomer which does not contain a fluorine atom, since a surface energy difference between the polyfunctional monomer and the fluorine-containing antifouling agent described above is large, the fluorine-containing antifouling agent functions to reduce a contact interface with the binder, whereby the fluorine-containing antifouling agent is apt to be distributed in the neighborhood of the surface. The surface energy of the fluorine-containing antifouling agent is preferably 23 mN/m or less, more preferably 16 mN/m or less, and most preferably 13 mN/m or less. The surface energy of the polyfunctional monomer acting as the binder is preferably 24 mN/m or more, more preferably 35 mN/m or more, and most preferably 45 mN/m or more.

In addition, it is effective for preventing the formation of a sea-island structure that the binder does not contain a fluorine atom. When the binder contains a fluorine atom, both the fluorine-containing antifouling agent and the fluorine-based compound of the binder exist in the neighborhood of the surface and these compounds are not mixed but cause phase separation, whereby the sea-island structure is formed in some cases.

The polyfunctional monomer for use in the invention includes a compound having a polymerizable functional group, for example, a (meth)acryloyl group, a vinyl group, a styryl group or an allyl group. Among them, a (meth)acryloyl group is preferred. A compound containing two or more (meth)acryloyl groups in its molecule is particularly preferably used. Such a compound is preferred, because a combinational effect on improvement in the scratch resistance or the scratch resistance after a chemical treatment is large particularly when a compound having a polymerizable unsaturated group in a polymer main body is used together.

Further, it is preferred that the polyfunctional monomer has a hydrophilic functional group, for example, a hydroxy group, an alkoxy group or an amino group. In case of using the polyfunctional monomer having a hydrophilic functional group, the maldistribution of the hydrophobic fluorine-containing antifouling agent at the surface is accelerated to improve the antifouling property and scratch resistance. Also, since the content of the antifouling agent can be reduced by using such a polyfunctional monomer, the transfer preventing property is further improved. Of the hydrophilic functional groups, a hydroxy group is particularly preferred.

Specific examples of the compound having a polymerizable unsaturated group include a (meth)acrylic acid diester of alkylene glycol, for example, neopentyl glycol acrylate, 1,6-hexanediol (meth)acrylate or propylene glycol di(meth)acrylate, a (meth)acrylic acid diester of polyoxyalkylene glycol, for example, triethylene glycol di(meth)acrylate, dipropylene glycol di(meth)acrylate, polyethylene glycol di(meth)acrylate or polypropylene glycol di(meth)acrylate, a (meth)acrylic acid diester of polyhydric alcohol, for example, pentaerythritol di(meth)acrylate, and a (meth)acrylic acid diester of ethylene oxide or propylene oxide adduct, for example, 2,2-bis{4-(acryloxy diethoxy)phenyl}propane or 2-2-bis{4-(acryloxy polypropoxy)phenyl}propane.

Further, an epoxy(meth)acrylate, a urethane (meth)acrylate and a polyester (meth)acrylate are also preferably used as the photopolymerizable polyfunctional monomer.

Among them, an ester of polyhydric alcohol and (meth)acrylic acid is preferred and a polyfunctional monomer having three or more (meth)acryloyl groups in its molecule is more preferred. Examples thereof include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acryl ate, dipentaerythritol tetra(meth)acrylate, dipentaerythritol penta(meth)acrylate, dipentaerythritol hex a(meth)acryl ate, pentaerythritol hexa(meth)acrylate, 1,2,3-cyclohexane tetramethacrylate, polyurethane polyacrylate, polyester polyacrylate and caprolactone-modified tris(acryloxyethyl)isocyanurate.

Specific examples of the polyfunctional acrylate-based compounds having a (meth)acryloyl group include an esterified product of polyol and (meth)acrylic acid, for example, KAYARAD DPHA, KAYARAD DPHA-2C, KAYARAD PET-30, KAYARAD TMPTA, KAYARAD TPA-320, KAYARAD TPA-330, KAYARAD RP-1040, KAYARAD T-1420, KAYARAD D-310, KAYARAD DPCA-20, KAYARAD DPCA-30, KAYARAD DPCA-60 or KAYARAD GPO-303 produced by Nippon Kayaku Co., Ltd. and V#3PA, V#400, V#36095D, V#1000 or V#1080 produced by Osaka Organic Chemical Industry Ltd. Further, a trifunctional or higher functional urethane acrylate compound, for example, Shiko UV-1400B, Shiko UV-1700B, Shiko UV-6300B, Shiko UV-7550B, Shiko UV-7600B, Shiko UV-7605B, Shiko UV-7610B, Shiko UV-7620EA, Shiko UV-7630B, Shiko UV-7640B, Shiko UV-6630B, Shiko UV-7000B, Shiko UV-7510B, Shiko UV-7461TE, Shiko UV-3000B, Shiko UV-3200B, Shiko UV-3210EA, Shiko UV-3310EA, Shiko UV-3310B, Shiko UV-3500BA, Shiko UV-3520TL, Shiko UV-3700B, Shiko UV-6100B, Shiko UV-6640B, Shiko UV-2000B, Shiko UV-2010B, Shiko UV-2250EA or Shiko UV-2750B (produced by The Nippon Synthetic Chemical Industry Co., Ltd.), UL-503LN (produced by Kyoeisha Chemical Co., Ltd.), UNIDIC 17-806, UNIDIC 17-813, UNIDIC V-4030 or UNIDIC V-4000BA (produced by Dainippon Ink & Chemicals, Inc.), EB-1290K, EB-220, EB-5129, EB-1830 or EB-4858 (produced by Daicel-UCB Company Ltd.), Ii-Coap AU-2010 or Hi-Coap AU-2020 (produced by Tokushiki Co., Ltd.), ARONIX M-1960 (produced by Toagosei Co., Ltd.) and Art Resin UN-3320HA, Art Resin UN-3320HC, Art Resin UN-3320HS, Art Resin UN-904 or Art Resin HDP-4T, and a trifunctional or higher functional polyester compound, for example, ARONIX M-8100, ARONIX M-8030 or ARONIX M-9050 (produced by Toagosei Co., Ltd.) and KRM-8307 (produced by DAICEL-CYTEC Company Ltd.) are also preferably used. Particularly, DPHA or PET-30 is preferably used.

Moreover, a resin having three or more (meth)acryloyl groups, for example, a relatively low molecular weight polyester resin, polyether resin, acrylic resin, epoxy resin, urethane resin, alkyd resin, spiroacetal resin, polybutadiene resin and polythiolpolyene resin, and an oligomer or prepolymer of a polyfunctional compound, for example, polyhydric alcohol are exemplified.

Furthermore, a dendrimer described, for example, in JP-A-2005-76005 and JP-A-2005-36105, or a norbornene ring-containing monomer described, for example, in JP-A-2005-60425 may also be used.

Two or more kinds of the polyfunctional monomers may be used in combination. The polymerization of such a monomer having an ethylenically unsaturated group can be performed by irradiation of ionizing radiation or heating in the presence of a photoradical initiator or a thermal radical initiator.

### (C) Inorganic Fine Particle

The coating composition for forming a low refractive index layer according to the invention contains an inorganic fine particle. From the standpoint of reduction of the refractive index and improvement in the scratch resistance, the inorganic fine particle is preferably used in the low refractive index layer. The inorganic fine particle preferably has a weight average particle size of 5 to 120 nm. From the standpoint of reduction of the refractive index, an inorganic low refractive index particle is preferable.

By using the coating composition for forming a low refractive index layer containing the inorganic fine particle, the surface migration of the fluorine-containing antifouling agent (A) during the formation of a layer is more amplified. Although the coating composition for forming a low refractive index layer is present in a uniformly mixed state just after the coating on a substrate, as the progress of drying the components thereof align to form a thermally stable structure. It is believed that since the inorganic fine particle is hydrophilic and has a high surface energy, whereas the fluorine-containing antifouling agent is hydrophobic and has a low surface energy, the fluorine-containing antifouling agent functions to reduce a contact interface with the inorganic fine particle, whereby the fluorine-containing antifouling agent is apt to be distributed in the neighborhood of the surface. As described above, the surface energy of the fluorine-containing antifouling agent is preferably 23 mN/m or less, more preferably 16 mN/m or less, and most preferably 13 mN/m or less. The surface energy of the inorganic fine particle is preferably 24 mN/m or more, more preferably 35 mN/m or more, and most preferably 45 mN/m or more. The surface energy of the inorganic fine particle is not limited to a surface energy of single inorganic fine particle and can be varied to the desired value according to surface modification using a known method.

The inorganic fine particle includes, because of low refractive index, a magnesium fluoride fine particle and a silica fine particle. In the invention, it is preferred that components other than the fluorine-containing antifouling agent (A) in the coating composition do not contain a fluorine atom and also from the standpoint of refractive index, dispersion stability and cost, a silica fine particle is preferred. The size (primary particle diameter) of the inorganic fine particle is preferably 15 nm or more and less than 100 nm, more preferably 20 nm or more and 80 nm or less, and most preferably 25 nm or more and 60 nm or less.

When the particle diameter of the inorganic fine particle is too small, the effect of improving the scratch resistance decreases, whereas when it is too large, fine irregularities are generated on the surface of the low refractive index layer and the appearance, for example, dense blackness or the integrated reflectivity may be deteriorated. The inorganic fine particle may be crystalline or amorphous, and it may be a monodisperse particle or an aggregate particle as long as the predetermined particle diameter is satisfied. The shape is most preferably sphere, but it may be other than sphere, for example, an amorphous form.

The coating amount of the inorganic fine particle is preferably from 1 to 100 mg/m², more preferably from 5 to 80 mg/m², and still more preferably from 10 to 60 mg/m². When the coating amount is too small, the effect of improving the scratch resistance decreases, whereas when it is too large, fine irregularities are generated on the surface of the low refractive index layer and the appearance, for example, dense blackness or the integrated reflectivity may be deteriorated.

Two or more inorganic fine particles different in an average particle size may be used in combination. The average particle size of the inorganic fine particle can be determined from electron micrographs.

### (Fine Particle Having Porous or Hollow Structure)

In order to reduce the refractive index, a fine particle having a porous or hollow structure is preferably used in the invention as the inorganic fine particle. Particularly, a silica fine particle having a hollow structure (hollow silica fine particle) is preferably used. The void percentage of the fine particle having a hollow structure is preferably from 10 to 80%, more preferably from 20 to 60%, and most preferably from 30 to 60%. The void percentage of the hollow fine particle in the range described above is preferable from the standpoint of reducing the refractive index and maintaining the durability of the particle. In particular, when the content of the inorganic fine particle is 30% by weight or more based on the total solid content of the coating composition, since the amount of the hydrophilic inorganic fine particle is decreased, the effect that the antifouling agent is apt to be distributed in the neighborhood of the surface in order to achieve thermal stability is strongly obtained.

In the case where the porous or hollow particle is silica, the refractive index of the fine particle is preferably from 1.10 to 1.40, more preferably from 1.15 to 1.35, and most preferably from 1.15 to 1.30. The refractive index as used herein indicates a refractive index of the particle as a whole, and does not indicate a refractive index of only silica in the outer shell forming the silica particle.

In the invention, the specific surface area of the hollow silica is preferably from 20 to 300 m²/g, more preferably from 30 to 120 m²/g, and most preferably from 46 to 90 m²/g. The surface area can be determined by a BET method using nitrogen. [0100]

In the invention, a void-free silica fine particle is also used. Also, the void-free silica fine particle may be used in combination with the hollow silica fine particle. The particle size of the void-free silica fine particle is preferably 30 nm or more and 150 nm or less, more preferably 35 nm or more and 100 nm or less, and most preferably 40 nm or more and 80 nm or less.

### [Preparation Method of Porous or Hollow Fine Particle]

A preferable preparation method of a hollow fine particle is described below. The first step is the formation of a core particle which can be removed by an after-treatment, the second step is the formation of a shell layer, the third step is the dissolution of the core particle, and if desired, the fourth step is the formation of an additional shell layer. Specifically, the hollow particle can be prepared, for example, in accordance with a preparation method of a hollow silica fine particle described in JP-A-2001-233611.

A preferable preparation method of a porous particle is a method where in the first step, a porous core particle is prepared by controlling the degree of hydrolysis or condensation of an alkoxide or the kind or amount of the coexisting substance, and in the second step, a shell layer is formed on the surface of the core particle. Specifically, the porous particle can be prepared, for example, by a method described, for example, in JP-A-2003-327424, JP-A-2003-335515, JP-A-2003-226516 or JP-A-2003-238140.

As the inorganic fine particle for use in the invention, fine particles described in Paragraph Nos. [0106] to [0113] of JP-A-2007-298974 are also preferred.

Specific examples and preferable examples of a surface treatment method of the inorganic fine particle for use in the invention are same as those described in Paragraph Nos. [0119] to [0147] of JP-A-2007-298974, respectively.

A dispersion method of the inorganic fine particle for use in the invention is same as that described in Paragraph Nos. [0148] to [0150] of JP-A-2007-298974. Also, specific examples and preferable examples of a metal chelate compound used for improving dispersibility are same as those described in Paragraph Nos. [0151] to [0153] of JP-A-2007-298974, respectively.

Specific examples and preferable examples of a photopolymerization initiator for use in the coating composition for forming a low refractive index layer according to the invention are same as those described in Paragraph Nos. [0191] to [0214] of JP-A-2007-298974, respectively.

### [Layer Construction of Antireflective Film]

The antireflective film of the invention can be prepared by providing one or plural functional layers demanded according to the purpose on a transparent substrate.

As one preferred embodiment, an antireflective film laminated on a transparent substrate, taking a refractive index, a film thickness, a number of layers, an order of layers and the like into consideration, so as to reduce the reflectivity by optical interference, is exemplified. The antireflective film is constructed from only a low refractive index layer applied to a transparent substrate according to the simplest construction. In order to further reduce the reflectivity, the antireflective layer preferably has a construction in which a high refractive index layer having a higher refractive index than that of the transparent substrate and a low refractive index layer having a lower refractive index than that of the transparent substrate are provided in combination. Examples of the construction include a two-layer construction having a high refractive index layer/low refractive index layer provided from the side of the transparent substrate, a construction having three layers having different refractive indices to form a laminate of a medium refractive index layer (layer having a higher refractive index than that of the transparent substrate and a lower refractive index than that of the high refractive index layer)/a high refractive index layer/a low refractive index layer in this order, and a construction having lamination of a larger number of antireflective layers is also proposed. Among them, a construction having a medium refractive index layer/a high refractive index layer/a low refractive index layer in this order on a transparent substrate having a hardcoat layer is preferred from the standpoint, for example, of durability, optical characteristics, cost or productivity, and examples thereof include constructions described, for example, in JP-A-8-122504, JP-A-8-110401, JP-A-10-300902, JP-A-2002-243906 and JP-A-2000-111706.

Further, a different function may be imparted on each layer, and examples of such a layer include a low refractive index layer having an antifouling property, a high refractive index layer having antistatic property (for example, JP-A-10-206603 or JP-A-2002-243906).

According to the invention, the medium refractive index layer is (A) a medium refractive index layer having a refractive index at a wavelength of 550 nm of 1.60 to 1.64 and a thickness of 55.0 to 65.0 nm, the high refractive index layer is (B) a high refractive index layer having a refractive index at a wavelength of 550 nm of 1.70 to 1.74 and a thickness of 105.0 to 115.0 nm, and the low refractive index layer is (C) a low refractive index layer having a refractive index at a wavelength of 550 nm of 1.33 to 1.38 and a thickness of 85.0 to 95.0 nm.

By adjusting the refractive index and thickness of each layer to the respective ranges described above, a change in the reflected color can be further reduced.

Furthermore, in the invention, with respect to the designed wavelength λ (=550 nm, which is representative of a wavelength region in which a luminous efficacy is highest), it is preferred that the medium refractive index layer satisfies equation (I) shown below, the high refractive index layer satisfies equation (II) shown below, and the low refractive index layer satisfies equation (III) shown below.

λ/4×0.68<n¹dⁱ<λ/4×0.74 Equation (I)

λ/2×0.66<n²d²<λ/2×0.72 Equation (II)

λ/4×0.84<n³d³<λ/4×0.92 Equation (III)

In the equations, n¹ is a refractive index of the medium refractive index layer, d¹ is a layer thickness (nm) of the medium refractive index layer, n² is a refractive index of the high refractive index layer, d² is a layer thickness (nm) of the high refractive index layer, n³ is a refractive index of the low refractive index layer, d³ is a layer thickness (nm) of the low refractive index layer, and n³<n¹<n².

It is preferred that equation (I), equation (II) and equation (III) are satisfied, since the reflectivity is lowered and the change in the reflected color can be inhibited. Further, this is also preferable from the standpoint that when a fat or oil component, for example, a fingerprint or sebum is attached, a change in the tint is small and thus the stain is hardly visible.

Although the hardcoat layer is not necessary to be provided according to the invention, it is preferred to be provided with the hardcoat layer as in the embodiment because the scratch resistance, for example, against scratch test with pencil is enhanced. Further, between the transparent substrate and the hardcoat layer a conductive layer may be provided separately from the medium refractive index layer and the high refractive index layer or the conductivity is imparted to the medium refractive index layer or the high refractive index layer to form the conductive layer.

It is preferred that the tint of regular reflecting light for incident light at an angle of 5 degree of a CIE standard light source D65 in a wavelength range from 380 to 780 nm satisfies following conditions that a* value and b* value in CIE1976 L*a*b* color space are in ranges of 0≦a*≦8 and −10≦b*≦0, respectively, and within the tint variation range, a color difference a due to 2.5% fluctuation in a thickness of at least one layer contained in the antireflective film falls in a range of equation (5) shown below, because the reflected color with good neutrality is obtained, the reflected color does not differ among the finished products, and when a fat or oil component, for example, a fingerprint or sebum is attached, the stain is hardly noticeable. By using the low refractive index layer containing the fluorine-containing antifouling agent having a polymerizable unsaturated group and the construction of the layers as described above in combination according to the invention, it can be achieved that a fat or oil component, for example, a magic marker, a fingerprint or sebum is hardly attached, even if attached, it is easily wiped off and is hardly noticeable.

ΔE={(L*−L*′)²+(a*−a*′)²+(b*−b*′)²}^{1/2}≦3 Equation (5)

wherein L*′, a*′ and b*′ indicate tint of reflected light at a designed film thickness.

Further, it is preferred in the case of the installation on the surface of an image display device that an average value of the specular reflectivity is adjusted to 0.5% or less, because the reflected glare image can be remarkably reduced.

Further, when the refractive index of the high refractive index layer is controlled, it is preferred to use the inorganic fine particle as described hereinafter, but a titanium dioxide particle which is conventionally used in the field brings about a problem, for example, light resistance deterioration due to its photocatalyst action and also a problem, for example, with preparation adaptability or durability in some cases. The inventors have found that by adjusting the refractive index of the high refractive index layer to the above-described range, it is unexpectedly possible to use an inorganic fine particle having a lower refractive index than that of the titanium dioxide particle, for example, a zirconium oxide particle, whereby the problem with preparation adaptability or durability can be solved.

As for the measurement of the specular reflectivity and the tint, the antireflection property can be evaluated by mounting an adapter “ARV-474” on a spectrophotometer “V-550” (produced by JASCO Corp.), measuring the specular reflectivity for the outgoing angle of −θ at an incident angle of θ (θ: from 5 to 45°, intervals of 5°) in the wavelength region of 380 to 780 nm, and calculating the average reflectivity at 450 to 650 nm. Further, the tint of reflected light can be evaluated by calculating from the reflection spectrum measured, the L*, a* and b* values of the CIE1976 L*a*b* color space which are values indicating the tint of regularly reflected light for incident light at each incident angle of a CIE standard illuminant D65.

The refractive index of each layer can be measured using Multi-Wavelength λbbe Refractometer DR-M2 (produced by ATAGO Co., Ltd.) after coating the coating solution of each layer on a glass plate so as to have a thickness of 3 to 5 μM. In the specification, a refractive index measured using a filter, “Interference Filter 546(e) nm for DR-M2, M4, RE-3523”, is employed as the refractive index at a wavelength of 550 nm.

The film thickness of each layer can be measured by observing the cross-section by means of “Reflective Film Thickness Monitor FE-3000 (produced by Otsuka Electronics Co., Ltd.) utilizing light interference or a TEM (transmission electron microscope). The refractive index can also be measured simultaneously with the film thickness by the reflection spectroscopy film thickness meter, but in order to increase the measurement accuracy of the film thickness, a refractive index of each layer measured by a different device is preferably used. In the case where the refractive index of each layer cannot be measured, the measurement of the film thickness by TEM is preferred. In this case, it is desirable to measure the film thickness at 10 or more portions and to use the average value thereof.

The antireflective film of the invention preferably takes a form, in terms of a form at the production, in which the film is in a roll. In this case, in order to obtain neutrality of the tint of the reflected color, the layer thickness distribution value calculated by formula (6) shown below with the parameters being the average d (average value), minimum d (minimum value) and maximum d (maximum value) of the layer thickness in the range of an arbitrary 1,000 m length is preferably 5% or less, more preferably 4% or less, still more preferably 3% or less, yet still more preferably 2.5% or less, and particularly preferably 2% or less, in each layer of the thin film layers.

(Maximum d−Minimum d)×100/Average d Equation (6)

Now, each of the layers which constitute the antireflective film according to the invention will be described in detail.

### [Transparent Substrate Film]

The transparent substrate film which is used as a transparent support of the antireflective film of the invention is not particularly limited and includes, for example, a transparent resin film, a transparent resin plate, a transparent resin sheet and a transparent glass. Examples of the transparent resin film include a cellulose acylate film (for example, a cellulose triacetate film (refractive index: 1.48), a cellulose diacetate film, a cellulose acetate butyrate film, a cellulose acetate propionate film), a polyethylene terephthalate film, a polyethersulfone film, a polyacrylic-based resin film, a polyurethane-based resin film, a polyester film, a polycarbonate film, a polysulfone film, a polyether film, a polymethylpentene film, a polyether ketone film, a (meth)acrylonitrile film, a polyolefin, a polymer having an alicyclic structure (a norbornene-based resin (Arton: trade name, produced by JSR Corp.) and an amorphous polyolefin (ZEONEX: trade name, produced by ZEON Corp.). Among them, triacetylcellulose, polyethylene terephthalate and a polymer having an alicyclic structure are preferred, and triacetylcellulose is particularly preferred.

The thickness of the transparent support used is ordinarily approximately from 25 to 1,000 μm, preferably from 25 to 250 μm, and more preferably from 30 to 90 μm,

The width of the transparent support may be appropriately selected and from the standpoint of handling, yield and productivity, it is ordinarily from 100 to 5,000 mm, preferably from 800 to 3,000 mm, and more preferably from 1,000 to 2,000 mm. The transparent support can be handled as a lengthy film in the roll form, and the length thereof is ordinarily from 100 to 5,000 m, and preferably from 500 to 3,000 m.

The surface of the transparent support is preferably smooth and an average roughness Ra value thereof is preferably 1 μm or less, more preferably from 0.0001 to 0.5 μm, and more preferably from 0.001 to 0.1 μm.

### (Cellulose Acylate Film)

Among them, a cellulose acylate film ordinarily used as a protective film of a polarizing plate is preferred because of high transparency, less optical birefringence and easy production, and a cellulose triacetate film is particularly preferred. The thickness of the transparent support is ordinarily approximately from 25 to 1,000 μm.

In the invention, a cellulose acetate having an acetylation degree of 59.0 to 61.5% is preferably used for the cellulose acylate film. The acetylation degree means the amount of acetic acid connected per unit weight of cellulose. The acetylation degree is determined according to the measurement and calculation of acetylation degree described in ASTM D-817-91 (Testing methods for cellulose acetate etc.). The viscosity average polymerization degree (DP) of the cellulose acylate is preferably 250 or more, more preferably 290 or more.

Also, in the cellulose acylate for use in the present invention, an Mw/Mn (Mw is a weight average molecular weight and Mn is a number average molecular weight) value by gel permeation chromatography is preferably close to 1.0, in other words, the molecular weight distribution is preferably narrow. Specifically, the Mw/Mn value is preferably from 1.0 to 1.7, more preferably from 1.3 to 1.65, and most preferably from 1.4 to 1.6.

In general, the substitution degree of the hydroxyl groups at the 2-, 3- and 6-positions of the cellulose acylate are not equally ⅓ distributed, but the substitution degree of 6-position hydroxyl group tends to be small. In the invention, however, the substitution degree of 6-position hydroxyl group of the cellulose acylate is preferably large in comparison with the 2- or 3-position.

The hydroxyl group at the 6-position is preferably substituted with an acyl group in a proportion of 32% or more, more preferably 33% or more, particularly preferably 34% or more, based on the entire substitution degree. Further, the substitution degree for the 6-position acyl group of cellulose acylate is preferably 0.88 or more. The 6-position hydroxyl group may be substituted, in addition to the acetyl group, with an acyl group having 3 or more carbon atoms, for example, a propionyl group, a butyroyl group, a valeroyl group, a benzoyl group or a acryloyl group. The substitution degree at each position can be measured by NMR.

As the cellulose acylate in the invention, cellulose acetates obtained by methods disclosed in Synthesis Example 1 in Paragraph Nos. [0043] and [0044], Synthesis Example 2 in Paragraph Nos. [0048] and [0049], and Synthesis Example 3 in Paragraph Nos. [0051] and [0052] of JP-A-11-5851 can be used.

### (Polyethylene Terephthalate Film)

In the invention, a polyethylene terephthalate film may also be preferably used, because the film is excellent in all of transparency, mechanical strength, planarity, chemical resistance and moisture resistance and moreover it is inexpensive.

The transparent plastic film is more preferably subjected to an easy adhesion treatment so as to further enhance the adhesion strength between the transparent plastic film and a hardcoat layer provided thereon. Examples of the commercially available optical PET film with an easy adhesion layer include COSMOSHINE A4100 and COSMOSHINE A4300 produced by Toyobo Co., Ltd.

### (Hardcoat Layer)

In the antireflective film of the invention, a hardcoat layer may be provided in order to impart physical strength to the antireflective film.

The antireflective film is constructed preferably by providing a low refractive index layer on the hardcoat layer, and more preferably by provided a medium refractive index layer and a high refractive index layer between the hardcoat layer and the low refractive index layer.

The hardcoat layer may be composed of a laminate of two or more layers.

The refractive index of the hardcoat layer in the invention is preferably from 1.48 to 2.00, more preferably from 1.48 to 1.60 in view of the optical design for obtaining an antireflective film. In the invention, since at least one low refractive index layer is present on the hardcoat layer, when the refractive index of the hardcoat layer is smaller than the above-described range, the antireflection property may decrease, whereas when it is excessively large, the tint of reflected light tends to be intensified.

The thickness of the hardcoat layer is ordinarily approximately from 0.5 to 50 μm, preferably from 1 to 20 μm, and more preferably 5 to 20 μm, from the standpoint of imparting sufficient durability and impact resistance to the antireflective film.

The strength of the hardcoat layer is preferably H or more, more preferably 2H or more, and most preferably 3H or more, in the pencil hardness test.

Further, in the Taber test according to JIS K5400, the abrasion loss of the specimen between before and after test is preferably smaller.

The hardcoat layer is preferably formed by a crosslinking reaction or polymerization reaction of an ionizing radiation-curable compound. For example, a coating composition containing an ionizing radiation-curable polyfunctional monomer or polyfunctional oligomer is coated on the transparent support and subjected to a crosslinking reaction or polymerization reaction of the polyfunctional monomer or polyfunctional oligomer, whereby the hardcoat layer can be formed.

The functional group in the ionizing radiation-curable polyfunctional monomer or polyfunctional oligomer is preferably a photo-, electron beam- or radiation-polymerizable functional group, more preferably a photopolymerizable functional group.

Examples of the photopolymerizable functional group include an unsaturated polymerizable functional group, for example, a (meth)acryloyl group, a vinyl group, a styryl group or an allyl group. Among them, a (meth)acryloyl group is preferred. Specifically, the compounds described in (B) Polyfunctional monomer having polymerizable unsaturated group above are preferably used.

For the purpose of imparting internal scattering property, the hardcoat layer may contain a matting particle, for example, an inorganic compound particle or a resin particle, having an average particle size from 1.0 to 10.0 μm, and preferably from 1.5 to 7.0 μm.

For the purpose of controlling the refractive index of the hardcoat layer, a high refractive index monomer, an inorganic fine particle or both may be added to the binder of the hardcoat layer. The inorganic fine particle has an effect of restraining the curing shrinkage resulting from the crosslinking reaction, in addition to the effect of controlling the refractive index. In the invention, the term “binder” means a polymer produced by the polymerization of the polyfunctional monomer and/or the high refractive index monomer or the like after the formation of the hardcoat layer including the inorganic particle dispersed therein.

For the purpose of maintaining the sharpness of the image, the transmitted image definition is preferably adjusted in addition to the adjustment of surface irregularity shape. The transmitted image definition of a clear antireflective film is preferably 60% or more. The transmitted image definition is ordinarily an index showing the degree of blur of an image transmitted and projected on the film and as the value is larger, the image viewed through the film is clearer and more preferable. The transmitted image definition is preferably 70% or more, and more preferably 80% or more.

Moreover, a conductive compound may be incorporated into the hardcoat layer in order to impart an antistatic property to the hardcoat layer, thereby improving the dust attachment property. The conductive compound which can be incorporated into the antistatic hardcoat layer is described below.

### (Conductive Compound)

The conductive compound for use in the invention is not particularly restricted as long as it has hydrophilicity and includes an ion conductive compound and an electron conductive compound.

The ion conductive compound includes, for example, a cationic, anionic, nonionic or amphoteric ion conductive compound. The electron conductive compound includes an electron conductive compound which is a non-conjugated polymer or conjugated polymer formed by connected aromatic carbon rings or aromatic hetero rings with a single bond or a divalent or higher valent connecting group.

Of the compounds, a compound (cationic compound) having a quaternary ammonium salt group is preferred from the standpoint of high antistatic property, relatively inexpensive and ease maldistribution in the region of the substrate side.

As the compound having a quaternary ammonium salt group, any of a low molecular weight type and a high molecular weight type may be used and a high molecular weight type cationic antistatic agent is preferably used because the fluctuation of antistatic property resulting, for example, from bleed out is prevented.

The high molecular weight type cationic compound having a quaternary ammonium salt group is used by appropriately selecting from known compounds and a polymer having at least one unit selected from the structural units represented by formulae (I) to (III) shown below is preferred from the standpoint of ease maldistribution in the region of the substrate side.

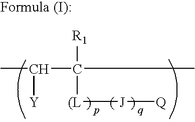

In formula (I), R₁ represents a hydrogen atom, an alkyl group, a halogen atom or a —CH₂COO⁻M⁺, Y represents a hydrogen atom or a —CH₂COO⁻M⁺, M⁺represents a proton or a cation, L represents —CONH—, —COO—, —CO— or —O—, J represents an alkylene group or an arylene group, and Q represents a group selected from Group A shown below.

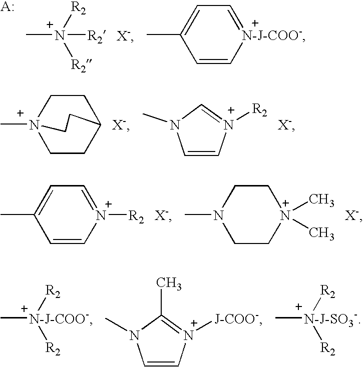

In the formulae above, R₂, R₂′ and R₂″ each independently represents an alkyl group, J represents an alkylene group or an arylene group, X⁻ represents an anion, and p and q each independently represents 0 or 1.

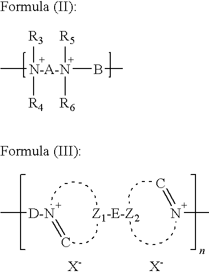

In formulae (II) and (III), R₃, R₄, R₅ and R₆ each independently represents an alkyl group, or R₃ and R₄ or R₅ and R₆ may be connected with each other to from a nitrogen-containing hetero ring.

A, B and D each independently represents an alkylene group, an arylene group, an alkenylene group, an arylenealkylene group, —R₇COR₈—, —R₉COOR₁₀OCOR₁₁—, —R₁₂OCOR₃COOR₁₄—, —R₁₅—(OR₁₆)ₘ—, —R₁₇CONHR₁₈NHCOR₁₉—, —R₂₀OCONHR₂₁NHCOR₂₂— or —R₂₃NHCONHR₂₄NHCONHR₂₅—, E represents a single bond, an alkylene group, an arylene group, an alkenylene group, an arylenealkylene group, —R₇COR₈—, —R₉COOR₁₀OCOR₁₁—, —R₁₂OCOR₁₃COOR₁₄—, —R₁₅—(OR₁₆)ₘ—, —R₁₇CONHR₁₈NHCOR₁₉—, —R₂₀OCONHR₂₁NHCOR₂₂—, —R₂₃NHCONHR₂₄NHCONHR₂₅— or —NHCOR₂₆CONH—, R₇, R₈, R₉, R₁₁, R₁₂, R₁₄, R₁₅, R₁₆, R₁₇, R₁₉, R₂₀, R₂₂, R₂₃, R₂₅ and R₂₆ each independently represents an alkyl group, R₁₀, R₁₃, R₁₈, R₂₁ and R₂₄ each independently represents a connecting group selected from an alkylene group, an alkenylene group, an arylene group, an arylenealkylene group and alkylenearylele group, m represents a positive integer of 1 to 4, and X⁻ represents an anion.

Z₁ and Z₂ each represents a nonmetallic atomic group necessary for forming a 5-membered or 6-memebered ring together with the —N═C— group and may be connected to E in the form of a quaternary salt of ≡N⁺[X⁻]—.

n represents an integer of 5 to 300.

The groups in formulae (I) to (III) are described in detail below.

The halogen atom includes a chlorine atom and a bromine atom and is preferably a chlorine atom.

The alkyl group is preferably a branched or a straight-chain alkyl group having from 1 to 4 carbon atoms, and more preferably a methyl group, an ethyl group or a propyl group.

The alkylene group is preferably an alkylene group having from 1 to 12 carbon atoms, more preferably a methylene group, an ethylene group or a propylene group, and particularly preferably an ethylene group.

The arylene group is preferably an arylene group having from 6 to 15 carbon atoms, more preferably a phenylene group, a diphenylene group, a phenylmethylene group, a phenyldimethylene group or a naphthylene group, and particularly preferably a phenymethylene group. These groups may have a substituent.

The alkenylene group is preferably an alkylene group having from 2 to 10 carbon atoms and the arylenealkylene group is preferably an arylenealkylene group having from 6 to 12 carbon atoms. These groups may have a substituent.

The substituent which may be present on each group includes, for example, a methyl group, an ethyl group and a propyl group.

In formula (I), R₁ is preferably a hydrogen atom.

Y is preferably a hydrogen atom.

J is preferably a phenymethylene group.

Q is preferably a group represented by formula (VI) shown below selected from Group A wherein R₂, R₂′ and R₂″ each independently represents a methyl group.

X⁻ represents, for example, a halide ion, a sulfonic acid anion or a carboxylic acid anion, preferably a halide ion, and more preferably a chloride ion.

p and q is each preferably 0 or 1, and more preferably p is 0 and q is 1.

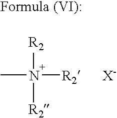

In formulae (II) and (III), R₃, R₄, R₅ and R₆ each preferably represents a substituted or unsubstituted alkyl group having from 1 to 4 carbon atoms, more preferably a methyl group or an ethyl group, and particularly preferably a methyl group.

A, B and D each independently preferably represents a substituted or unsubstituted alkylene group having from 2 to 10 carbon atoms, an arylene group, an alkenylene group . or an arylenealkylene group, and more preferably a phenyldimethylene group.

X⁻ represents, for example, a halide ion, a sulfonic acid anion or a carboxylic acid anion, preferably a halide ion, and more preferably a chloride ion.

E preferably represents a single bond, an alkylene group, an arylene group, an alkenylene group or an arylenealkylene group.

The 5-membered or 6-membered ring formed by Z₁ or Z₂ together with the —N═C— group includes, for example, a diazoniabiscyclooctane ring.

Specific examples of the compound having a structural unit represented by any one of formulae (I) to (III) are set forth below, but the invention should not be construed as being limited thereto. Of the suffixes (m, x, y, z and numeral numbers) shown in the specific examples, m represents a number of repeating units of each unit, and x, y and z each represents a molar ratio of each unit.

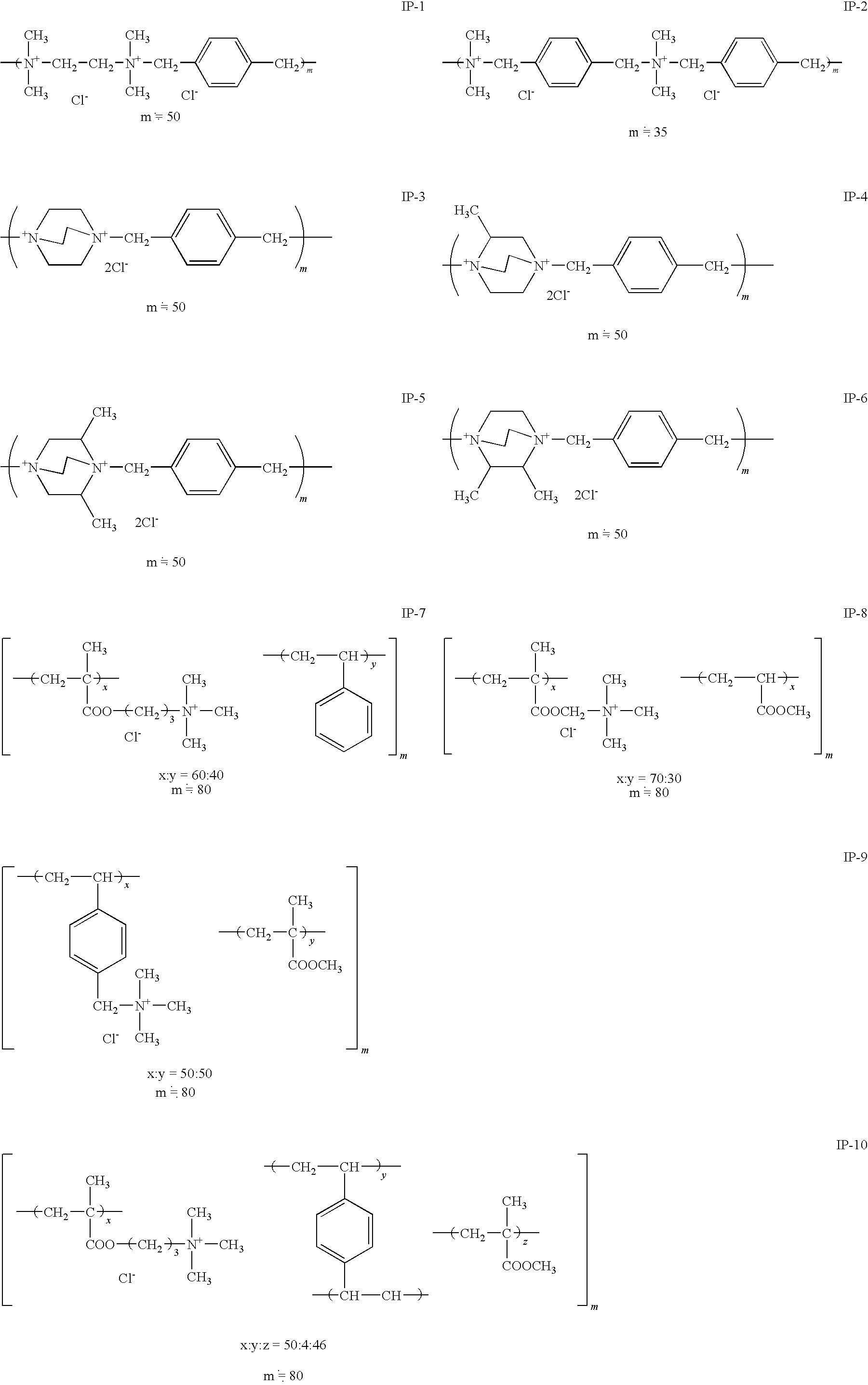

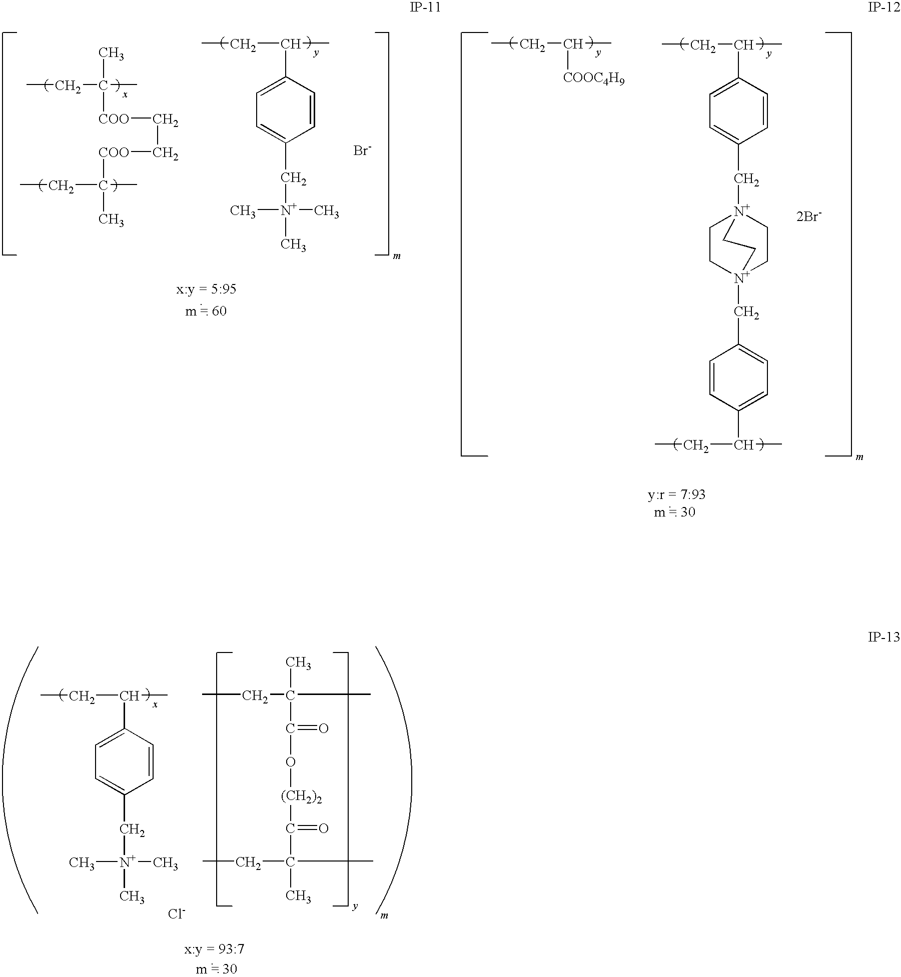

The conductive compounds illustrated above may be used individually or in combination of two or more thereof. The antistatic compound having a polymerizable group in its molecule is preferable because it can also increase the scratch resistance (film strength) of the antistatic hardcoat layer.

The electron conductive compound is preferably a non-conjugated polymer or conjugated polymer formed by connected aromatic carbon rings or aromatic hetero rings with a single bond or a divalent or higher valent connecting group. The aromatic carbon ring in the non-conjugated polymer or conjugated polymer includes, for example, a benzene ring which may further form a condensed ring. The hetero ring in the non-conjugated polymer or conjugated polymer includes, for example, a pyridine ring, a pyrazine ring, a pyrimidine ring, a pyridazine ring, a triazine ring, an oxazole ring, a thiazole ring, an imidazole ring, an oxadiazole ring, thiadiazole ring, a triazole ring, a tetrazole ring, a furan ring, a thiophene ring, a pyrrole ring, an indole ring, a carbazole ring, a benzimidazole ring and an imidazopyridine ring. There rings may further form a condensed ring and may have a substituent.

The divalent or higher valent connecting group in the non-conjugated polymer or conjugated polymer includes a connecting group formed from a carbon atom, a silicon atom, a nitrogen atom, a boron atom, an oxygen atom, a sulfur atom, metal and a metal ion, and preferably a group formed from a carbon atom, a nitrogen atom, a silicon atom, a boron atom, an oxygen atom, a sulfur atom and a combination thereof. Examples of the group formed by combination include a methylene group, a carbonyl group, an imino group, a sulfonyl group, a sulfinyl group, an ester group, an amido group and a silyl group each of which may be substituted.

Specific examples of the electron conductive compound include conductive polyaniline, polyparaphenylene, polyparaphenylenevynylene, polythiophene, polyfuran, polypyrrole, polyselenophene, polyisothianaphthene, polyphenylene sulfide, polyacetylene, polypyridylvinylene, polyazine and derivatives thereof each of which may be substituted. The electron conductive compounds may be used individually or in combination of two or more thereof according to the purpose.

If the desired conductivity is achieved, it may be used in the form of a mixture with other polymer having no conductivity, and a copolymer of a monomer capable forming the conductive polymer with other monomer having no conductivity may also be used.

The electron conductive compound is more preferably a conjugated polymer. Examples of the conjugated polymer include polyacethylene, polydiacetylene, poly(paraphenylene), polyfluorene, polyazulene, poly(paraphenylene sulfide), polypyrrole, polythiophene, polyisothianaphthene, polyaniline, poly(paraphenylenevinylene), poly(2,5-thienylenevinylene), a multiple chain type conjugated polymer (e.g., polyperinaphthalene), a metal phthalocyanine-type polymer, other conjugated polymer (e.g., poly(paraxylylene) or poly[α-(5,5′-bithiophenediypbenzylidene]) and derivatives thereof.

Poly(paraphenylene), polypyrrole, polythiophene, polyaniline, poly(paraphenylenevinylene), poly(2,5-thienylenevinylene) and derivatives thereof are preferred, polythiophene, polyaniline, polypyrrole and derivative thereof are more preferred, and polythiophene and a derivative thereof are still more preferred.

Specific examples of the electron conductive compound are set forth below, but the invention should not be construed as being limited thereto. In addition, for example, compounds described in WO 98/01909 are also illustrated.

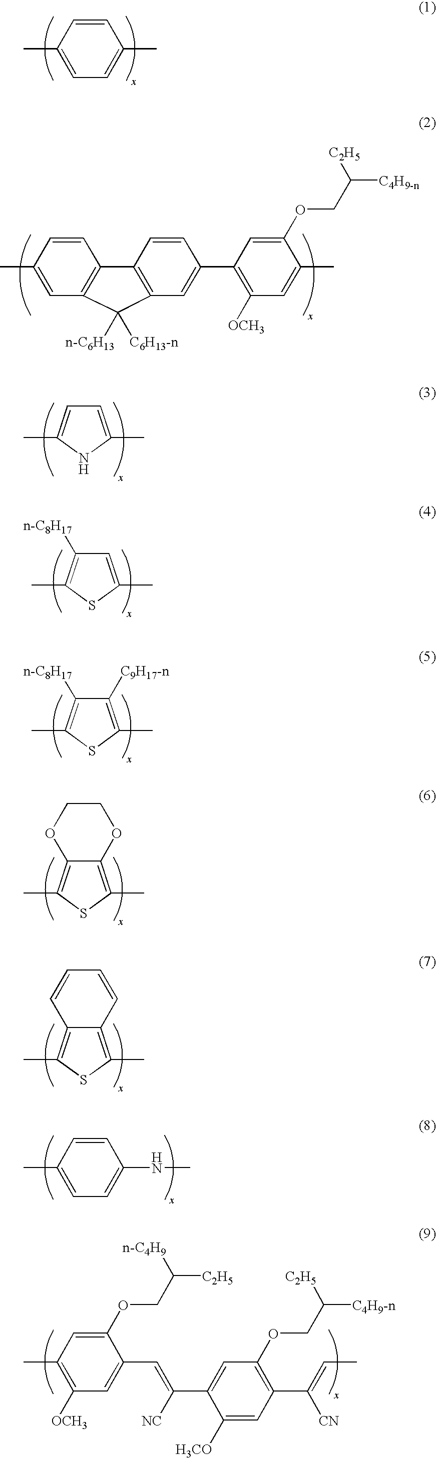

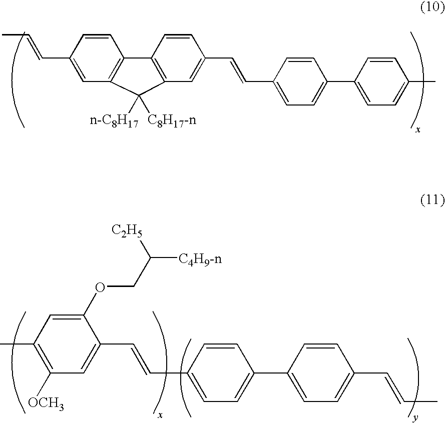

A weight average molecular weight of the electron conductive compound for use in the invention is preferably from 1,000 to 1,000,000, more preferably from 10,000 to 500,000, and still more preferably from 10,000 to 100,000. The weight average molecular weight is a weight average molecular weight measured by gel permeation chromatography and calculated in terms of polystyrene.

The electron conductive compound for use in the invention is preferably soluble in an organic solvent from the standpoint of the coating property and imparting affinity with other components. The term “soluble” as used herein means a state where the compound is dissolved in the solvent as a single molecule state or as a association state of plural single molecules or state where the compound is dispersed in the solvent as a particle having particle size of 300 nm or less.

Since the electron conductive compound is ordinarily dissolved in a solvent mainly comprising water, the electron conductive compound has hydrophilicity. In order to solubilize the electron conductive compound in an organic solvent, a compound (for example, a solubilizing-aid agent) which increases affinity with the organic solvent or a dispersant in the organic solvent is added to the composition containing the electron conductive compound or a hydrophobically treated polyanion dopant is used. Although the electron conductive compound is made soluble also in an organic solvent used in the invention using the method described above, it still has the hydrophilicity so that the maldistribution of conductive compound can be formed using the method according to the invention.

In the case of using the compound having a quaternary ammonium salt group as the conductive compound, it is preferred that a nitrogen or sulfur atom content on the surface side of the antistatic hardcoat layer according to elemental analysis (ESCA) is from 0.5 to 5% by mole. In the range described above, good antistatic property is easily obtained. The content is more preferably from 0.5 to 3.5% by mole, and still more preferably from 0.5 to 2.5% by mole.

It is also preferred that a nitrogen atom content ratio or sulfur atom content ratio of the antistatic hardcoat layer according to elemental analysis (ESCA) satisfies equation (1) shown below.

β/α>2.5 Equation (1)

In equation (1), β represents a nitrogen or sulfur atom content in the cellulose acylate film side region of the antistatic hardcoat layer determined by the elemental analysis and α represents a nitrogen or sulfur atom content in the surface side region of the antistatic hardcoat layer determined by the elemental analysis, taking the total nitrogen or sulfur atom content in the antistatic hardcoat layer 100% by mole.

It is preferred that β/α>2.5, because good antistatic property and good chemical resistance are obtained. It is more preferred that 6.5>β/α>2.5.

In the elemental analysis by ESCA, the antistatic hardcoat layer is etched from the surface by a certain depth with a predetermined etching rate to conduct elemental analysis and the operation is repeatedly performed to determine the change of composition in the depth direction from the surface to the inside of the antistatic hardcoat layer. The method of etching for detecting the change of composition is not limited and the etching using C60 ion gun is preferable in the measurement of the change of composition in the depth direction of an organic compound layer, because damage of the sample can be reduced.

The antistatic hardcoat layer can be formed by coating a coating composition containing the conductive compound having hydrophilicity and a solvent on a substrate film, followed by drying.

The antistatic hardcoat layer may also be fofted by further adding a polyfunctional monomer having two or more polymerizable groups and a photopolymerization initiator to the coating composition and curing the polyfunctional monomer after the coating. In the antistatic hardcoat layer thus-formed, hardness of the layer is increased so that the film strength and scratch resistance can be improved.

### (Antiglare Layer)

The antiglare layer is formed for the purpose of providing the antireflective film with an antiglare property due to surface scattering and preferably with a hardcoat property to enhance the hardness and scratch resistance of the antireflective film.

In order to form the antiglare layer, a known method can be utilized, for example, a method of forming the antiglare layer by laminating a matted film having fine irregularities on its surface as described in JP-A-6-16851, a method of forming the antiglare layer by varying the irradiation dose of ionizing radiation to bring about curing shrinkage of an ionizing radiation-curable resin as described in JP-A-2000-206317, a method where a weight ratio of a good solvent to a light-transmitting resin is decreased upon drying and a light-transmitting fine particle and the light-transmitting resin are gelled and solidified to form irregularities on the coating film surface as described in JP-A-2000-338310, or a method of imparting surface irregularities by applying an external pressure as described in JP-A-2000-275404.

The antiglare layer which can be used in the invention is preferably a layer containing, as the essential components, a binder capable of imparting the hardcoat property, a light-transmitting particle for imparting the antiglare property and a solvent, in which surface irregularities are formed by protrusion of the light-transmitting particle itself or protrusion formed by an aggregate of a plurality of the light-transmitting particles.

The antiglare layer formed by the dispersion of matting particles is composed of a binder and a light-transmitting particle dispersed in the binder. The antiglare layer having the antiglare property preferably has both the antiglare property and the hardcoat property.

### [High Refractive Index Layer and Medium Refractive Index Layer)

The refractive index of the high refractive index layer is preferably from 1.70 to 1.74, and more preferably from 1.71 to 1.73. The refractive index of the medium refractive index layer is adjusted so as to be between the refractive index of the low refractive index layer and the refractive index of the high refractive index layer. The refractive index of the medium refractive index layer is preferably from 1.60 to 1.64, and more preferably from 1.61 to 1.63.

As for a method for forming the high refractive index layer or the medium refractive index layer, although a transparent thin film of inorganic oxide formed by a chemical vapor deposition (CVD) method or a physical vapor deposition (PVD) method, particularly, a vacuum deposition method or a sputtering method, which is a kind of the physical vapor deposition method, may be used, a method of all-wet coating is preferred.

The medium refractive index layer can be prepared in the same manner using the same materials as the high refractive index layer, except that the refractive index is different from that of the high refractive index layer, and therefore, the high refractive index layer is particularly described below.

The medium refractive index layer or high refractive index layer is preferably formed by coating a coating composition containing an inorganic fine particle containing an oxide of at least one metal selected from Ti, Zr, In, Zn, Sn, Al and Sb, a curable resin (hereinafter also referred to as a “binder” sometimes) containing a trifunctional or higher functional polymerizable group, a solvent and a polymerization initiator, drying the solvent, and then curing the coating by either one or both means of heating and irradiation of ionizing radiation. In the case of using the curable resin and the initiator, the curable resin is cured upon a polymerization reaction by means of heat and/or ionizing radiation after coating, whereby a medium refractive index layer or high refractive index layer having excellent scratch resistance and adhesion property can be formed.

### (Inorganic Fine Particle)

The inorganic fine particle is preferably a fine particle of an oxide of metal (for example, Ti, Zr, In, Zn, Sn, Sb and Al, and most preferably a fine particle of zirconium oxide in view of the refractive index. From the standpoint of conductivity, it is preferred to use an inorganic fine particle in which the main component is an oxide of at least one metal of Sb, In and Sn. The refractive index can be adjusted to the predetermined range by changing an amount of the inorganic fine particle. The average particle size of the inorganic fine particle in the layer is, when zirconium oxide is used as the main component, preferably from 1 to 120 nm, more preferably from 1 to 60 nm, and still more preferably from 2 to 40 nm. The range is preferred because the haze is inhibited and dispersion stability and adhesion property to the upper layer due to appropriate irregularities on the surface are improved.

The refractive index of the inorganic fine particle comprising zirconium oxide as the main component is preferably from 1.90 to 2.80, more preferably from 2.00 to 2.40, and most preferably from 2.00 to 2.20.

The amount of the inorganic fine particle added may vary depending on the layer to which the inorganic fine particle is added, and in the medium refractive index layer, the amount added is preferably from 20 to 60% by weight, more preferably from 25 to 55% by weight, and still more preferably from 30 to 50% by weight, based on the solid content of the entire medium refractive index layer. In the high refractive index layer, the amount added is preferably from 40 to 90% by weight, more preferably from 50 to 85% by weight, and still more preferably from 60 to 80% by weight, based on the solid content of the entire high refractive index layer.

The particle size of the inorganic fine particle can be measured by a light-scattering method or an electron micrograph.

The specific surface area of the inorganic fine particle is preferably from 10 to 400 m²/g, more preferably from 20 to 200 m²/g, and most preferably from 30 to 150 m²/g.

For the purpose of enhancing dispersion stability in a dispersion or coating solution or increasing the compatibility or binding property with a binder component, the inorganic fine particle may be subjected to a physical surface treatment, for example, a plasma discharge treatment or a corona discharge treatment or a chemical surface treatment, for example, with a surfactant or a coupling agent. Use of the coupling agent is particularly preferred. As for the coupling agent, an alkoxy metal compound (for example, a titanium coupling agent or a silane coupling agent) is preferably used. Among them, a treatment with a silane coupling agent having an acryloyl group or methacryloyl group is particularly effective. Chemical surface treating agents of inorganic fine particle, solvents, catalysts and stabilizers of dispersion are described in Paragraph Nos. [0058] to [0083] of JP-A-2006-17870.

The inorganic fine particle can be dispersed using a disperser. Examples of the disperser include a sand grinder mill (for example, a bead mill with pin), a high-speed impeller mill, a pebble mill, a roller mill, an attritor and a colloid mill. Among them, a sand grinder mill and a high-speed impeller mill are particularly preferred. A preliminary dispersion treatment may be conducted. Examples of the disperser for use in the preliminary dispersion treatment include a ball mill, a three-roll mill, a kneader and an extruder.

The inorganic fine particle is preferably dispersed in the dispersion medium to have a particle size as small as possible. The weight average particle size thereof is from 10 to 120 nm, preferably from 20 to 100 nm, more preferably from 30 to 90 nm, and particularly preferably from 30 to 80 nm.

By dispersing the inorganic fine particle to a small particle size of 200 nm or less, the high refractive index layer and the medium refractive index layer can be formed without impairing transparency.

Also, the medium refractive index layer or the high refractive index layer may contain a conductive inorganic fine particle. The conductive inorganic fine particle is same as the conductive inorganic fine particle in the conductive layer described hereinafter and preferable examples thereof are also the same.

### (Curable Resin)

The curable resin is preferably a polymerizable compound and as the polymerizable compound, an ionizing radiation curable polyfunctional monomer or polyfunctional oligomer is preferably used. The functional group in the compound is preferably a photo-, electron beam- or radiation-polymerizable functional group and among them, a photopolymerizable functional group is preferred. Examples of the photopolymerizable functional group include an unsaturated polymerizable functional group, for example, a (meth)acryloyl group, a vinyl group, a styryl group or an allyl group and among them, a (meth)acryloyl group is preferred.

As specific examples the photopolymerizable polyfunctional monomer having a photopolymerizable functional group, the compounds described in (B) Polyfunctional monomer having polymerizable unsaturated group above can be preferably used.

In the high refractive index layer, a surfactant, an antistatic agent, a coupling agent, a thickener, a coloration inhibitor, a coloring agent (for example, pigment or dye), a defoaming agent, a leveling agent, a flame retardant, an ultraviolet absorber, an infrared absorber, an adhesion-imparting agent, a polymerization inhibitor, an antioxidant, a surface modifier, a conductive metal fine particle and the like may be added in addition to the above-described component (for example, an inorganic fine particle, a curable resin, a polymerization initiator or a photosensitizer).

The high refractive index layer and the medium refractive index layer for use in the present invention are each preferably formed as follows. A curable resin (for example, the ionizing radiation curable polyfunctional monomer or polyfunctional oligomer described above) as a precursor of binder necessary for the formation of matrix, a photopolymerization initiator and the like are added to a dispersion obtained by dispersing the inorganic fine particle in a dispersion medium as described above to prepare a coating composition for forming the high refractive index layer or the medium refractive index layer, and the coating composition for forming the high refractive index layer or the coating composition for forming the medium refractive index layer is coated on a transparent support and cured upon a crosslinking reaction or polymerization reaction of the curable resin.

Simultaneously with or after the coating of the high refractive index layer or the medium refractive index layer, the binder of the layer is preferably crosslinked or polymerized with the dispersant. The binder in the high refractive index layer or medium refractive index layer thus-prepared takes a form, for example, in that the above-described preferable dispersant and the ionizing radiation curable polyfunctional monomer or polyfunctional oligomer undergo a crosslinking reaction or polymerization reaction, whereby an anionic group of the dispersant is taken in the binder. The anionic group taken in the binder of the high refractive index layer or medium refractive index layer has a function of maintaining the dispersion state of the inorganic fine particle and the crosslinked or polymerized structure imparts a film-forming ability to the binder, whereby the physical strength, chemical resistance and weather resistance of the high refractive index layer or medium refractive index layer containing the inorganic fine particle are improved.

In the formation of the high refractive index layer, the crosslinking reaction or polymerization reaction of the curable resin is preferably conducted under an atmosphere having an oxygen concentration of 10% by volume or less.

When the high refractive index layer is formed under the atmosphere having an oxygen concentration of 10% by volume or less, the physical strength, chemical resistance and weather resistance are improved and further the adhesion property between the high refractive index layer and a layer adjacent to the high refractive index layer can be improved.

The layer formation upon the crosslinking reaction or polymerization reaction of the curable resin is preferably conducted under an atmosphere having an oxygen concentration of 6% by volume or less, more preferably 4% by volume or less, particularly preferably 2% by volume or less, and most preferably 1% by volume or less.

The thickness of the high refractive index layer is preferably from 105 to 115 nm, and more preferably from 107.5 to 112.5 nm. The thickness of the medium refractive index layer is preferably from 55 to 65 nm, and more preferably from 58.5 to 61.5 nm.

As described above, the medium refractive index layer can be formed using the same materials in the same manner as the high refractive index layer,

Specifically, for example, the main composition is formulated by selecting the kind of fine particle and the kind of resin and determining the mixing ratio thereof in order that the medium refractive index layer and the high refractive index layer can satisfy the film thickness and refractive index of equations (I) and (II) described above.

### [Low Refractive Index Layer]

The refractive index of the low refractive index layer according to the invention is preferably from 1.30 to 1.47. The refractive index of the low refractive index layer in the case of the antireflective film of a multi-layer thin film interference type (medium refractive index layer/high refractive index layer/low refractive index layer) is preferably from 1.33 to 1.38, and more preferably from 1.35 to 1.37. The range is preferred because the film strength can be maintained while reducing the reflectivity. As for a method of forming the low refractive index layer, although a transparent thin film of inorganic oxide formed by a chemical vapor deposition (CVD) method or a physical vapor deposition (PVD) method, particularly, a vacuum deposition method or a sputtering method, which is a kind of the physical vapor deposition method, may be used, a method of all-wet coating using the coating composition for forming a low refractive index layer described hereinafter is preferably used. The low refractive index layer preferably contains an inorganic fine particle, and at least one of the inorganic fine particles is preferably a hollow particle and particularly preferably a hollow particle (hereinafter, also referred to as a “hollow silica particle”) containing silica as the main component.

The thickness of the low refractive index layer is preferably from 85.0 to 95.0 nm, and more preferably from 88.0 to 92.0 nm.

The haze of the low refractive index layer is preferably 3% or less, more preferably 2% or less, and most preferably 1% or less.

The strength of the antireflective film including the low refractive index layer formed is preferably H or more, more preferably 2H or more, and most preferably 3H or more, in a pencil hardness test with a load of 500 g.

Also, in order to improve the antifouling performance of the antireflective film, the contact angle to water on its surface is preferably 90° or more, more preferably 95° or more, and particularly preferably 100° or more.

### (Formation of Low Refractive Index Layer)

The low refractive index layer is preferably formed by coating a coating composition having dissolved or dispersed therein (A) a fluorine-containing antifouling agent having a polymerizable unsaturated group, (B) a polyfunctional monomer having a polymerizable unsaturated group, (C) an inorganic fine particle, and, if desired, (D) a photopolymerization initiator and other arbitrary components, and simultaneously with the coating or after the coating and drying, curing the coating upon a crosslinking reaction or polymerization reaction by the irradiation of ionizing radiation (for example, irradiation of light or irradiation of electron beam) or heating.

In particular, when the low refractive index layer is formed upon the crosslinking reaction or polymerization reaction of an ionizing radiation curable compound, the crosslinking reaction or polymerization reaction is preferably conducted under an atmosphere having an oxygen concentration of 1% by volume or less. When the low refractive index layer is formed under an atmosphere having an oxygen concentration of 1% by volume or less, the outermost layer excellent in the physical strength and chemical resistance can be obtained.

The oxygen concentration is preferably 0.5% by volume or less, more preferably 0.1% by volume or less, particularly preferably 0.05% by volume or less, and most preferably 0.02% by volume or less.

As a means of reducing the oxygen concentration to 1% by volume or below, replacement of the air (nitrogen concentration: about 79% by volume, oxygen concentration: about 21% by volume) with other gas is preferable, and replacement with nitrogen (purging by nitrogen) is particularly preferred.

### [Surface Energy of Antireflective Film]

The surface energy of the outermost surface of the antireflective film can be variously changed. In order to increase the antifouling property, it is preferred to decrease the surface energy. The surface energy of the outermost surface of the antireflective film is preferably 23 mN/m or less, more preferably 16 mN/m or less, and most preferably 13 mN/m or less. When the surface energy is 23 mN/m or less, the attachment of an oily component, for example, a fingerprint can be reduced and the surface to which wiping off of the stain is not necessary can be provided.

### [Surface Roughness of Antireflective Film]

In the case of imparting the antifouling property by mixing the fluorine-containing antifouling agent with other components, when the surface migration property of the antifouling agent is insufficient or compatibility of the antifouling agent with other components is insufficient, a sea-island structure composed of the antifouling agent and other components may be formed on the surface. When the sea-island structure is formed and unevenness of the density of the antifouling agent occurs in the direction from the surface to the inside of the layer, the anti-fouling property degrades. The surface free from the unevenness of the density of the antifouling agent can decrease the attachment of stain and does not require wiping off of the stain.

The formation of sea-island structure can be confirmed by observation with an optical microscope or an atomic forth microscope (AFM) depending on the size thereof. When the above-described cause exists, the domain where the antifouling agent or other components forms an aggregate is generated, whereby an irregularity occurs. The average surface roughness (Ra) measured by AFM is preferably less than 10 nm, more preferably less than 5 nm, and most preferably less than 3 nm. The R^{a} is preferably determined, for example, according to JIS (1982). As AFM, for example, STA-400 produced by SII can be used. The formation of the sea-island structure means that the case where the above-described domain is observed by AFM and the average surface roughness is 10 nm or more.

### [Conductive Layer]

The antireflective film according to the invention can exhibit the low refractive index and excellent antifouling property, but since fluorine is oriented on the surface of the coated film, the conductivity is poor to cause deterioration in the dust resistance. Therefore, the antireflective film preferably has a conductive layer from the standpoint of preventing the static electricity on the surface -thereof according to the invention. The conductive layer may be provided separately from the low refractive index layer, high refractive index layer, medium refractive index layer or hardcoat layer described above or the layer may also be made to serve as the conductive layer. The conductive layer may be provided as a layer located between the layers or as a layer located between the transparent. support and the layer closest to the transparent support. The thickness of the conductive layer is preferably from 0.01 to 10 μm, more preferably from 0.03 to 7 μm, and still more preferably from 0.05 to 5 μm. The materials for use in the conductive layer and the performance of the conductive layer are described in detail below.

In the invention, at least one layer of the layers constituting the antireflective film can be formed as a conductive layer. Specifically, it is extremely preferable that at least any one layer of the low refractive layer, medium refractive index layer and high refractive index layer is formed as a conductive layer by imparting conductivity since it can simplify the process. In this case, the materials of the conductive layer are preferably selected so that the thickness and the refractive index of the layer can satisfy the condition of the medium refractive index layer and the high refractive index layer described above. Since the low refractive index layer is the surface layer or a layer close to the surface of the antireflective film, it is most preferred that the conductivity is imparted to the low refractive index layer from the standpoint of preventing the static electricity on the surface of the antireflective film. However, there is a problem in that in many cases, the conductive particle or compound is a material having a high refractive index and the desired low refractive index can be hardly obtained. Since the conductive particle or compound is a material having a high refractive index, conductivity can be easily and preferably imparted to the medium or the high refractive index layer.

The conductive layer preferably has a surface resistance (SR) satisfying the following equation (4).

Log SR≦12 Equation (4)

The Log SR is preferably from 5 to 12, more preferably from 5 to 9, and most preferably from 5 to 8. The surface resistance (SR) of the conductive layer can be measured by a four-probe method or a circular electrode method.

The conductive layer is preferably substantially transparent. Specifically, the haze of the conductive layer is preferably 10% or less, more preferably 5% or less, still more preferably 3% or less, and most preferably 1% or less. Further, the transmittance for light at a wavelength of 550 nm is preferably 50% or more, more preferably 60% or more, still more preferably 65% or more, and most preferably 70% or more.

### (Conductive Inorganic Fine Particle of Conductive Layer)

The conductive layer can be formed using a coating composition prepared by dissolving a conductive inorganic fine particle and a reactive curable resin in a solvent. In this case, the conductive inorganic fine particle is preferably formed of a metal oxide or nitride. Examples of the metal oxide or nitride include tin oxide, indium oxide, zinc oxide and titanium nitride. Among them, tin oxide and indium oxide are particularly preferred. The conductive inorganic fine particle comprises such a metal oxide or nitride as the main component and may further contain other element. The main component means a component having a largest content (% by weight) of the components constituting the particle. Examples of the other element include Ti, Zr, Sn, Sb, Cu, Fe, Mn, Pb, Cd, As, Cr, Hg, Zn, Al, Mg, Si, P, S, B, Nb, In, V and a halogen atom. In order to increase the conductivity of tin oxide or indium oxide, addition of at least one of Sb, P, B, Nb, In, V and a halogen atom is preferred. More specifically, one or two or more metal oxides selected from the group consisting of tin-doped indium oxide (ITO), antimony-doped tin oxide (ATO), fluorine-doped tin oxide (FTO), phosphorus-doped tin oxide (PTO), zinc antimonate (AZO), indium-doped zinc oxide (IZO), zinc oxide, ruthenium oxide, rhenium oxide, silver oxide, nickel oxide and copper oxide is preferably used. Among them, tin-doped indium oxide (ITO), antimony-doped tin oxide (ATO) and phosphorus-doped tin oxide (PTO) are particularly preferred. The Sb proportion in ATO is preferably from 3 to 20% by weight, and the In proportion in ITO is preferably from 5 to 20% by weight.

The average particle size of the primary particle of the conductive inorganic fine particle for use in the conductive layer is preferably from 1 to 150 nm, more preferably from 5 to 100 nm, and most preferably from 5 to 70 nm. The average particle size of the conductive inorganic fine particle in the conductive layer formed is from 1 to 200 nm, preferably from 5 to 150 nm, more preferably from 10 to 100 nm, and most preferably from 10 to 80 nm. The average particle size of the conductive inorganic fine particle is an average diameter weighed by the weight of the particle and can be measured by a light scattering method or an electron micrograph.

The conductive inorganic fine particle may be subjected to a surface treatment. The surface treatment is conducted using an inorganic compound or an organic compound. Examples of the inorganic compound for use in the surface treatment include alumina and silica. A silica treatment is particularly preferred. Examples of the organic compound for use in the surface treatment include a polyol, an alkanolamine, stearic acid, a silane coupling agent and a titanate coupling agent. A silane coupling agent is most preferred. Specifically, the method described with respect to the surface treatment method of the inorganic fine particle described in (C) inorganic fine particle which is the constituting component according to the invention is preferably used. Further, a method described in Paragraph Nos. [0101] to [0122] of JP-A-2008-31327 can also be preferably used. Two or more kinds of surface treatments may be conducted in combination.

Two or more kinds of conductive inorganic fine particles may be used in combination in the conductive layer.

The content of the conductive inorganic fine particle in the conductive layer is preferably from 20 to 90% by weight, more preferably from 25 to 85% by weight, and most preferably from 30 to 80% by weight, based on the total solid content.

It is preferred that the conductive inorganic compound particle is reacted with an alkoxysilane compound in an organic solvent. By using a reaction solution prepared by previously reacting the conductive inorganic compound particle with the alkoxysilane compound, the effect excellent in preservation stability and curability can be achieved.

Examples of the commercially available product as powder of the conductive inorganic oxide particle include T-1 (ITO) (produced by Mitsubishi Material Corp.), Pastran (ITO, ATO) (produced by Mitsui Mining & Smelting Co., Ltd.), SN-100P (ATO) (produced by Ishihara Sangyo Kaisha, Ltd.), NanoTek ITO (produced by C.I. Kasei Co., Ltd.), ATO and FTO (produced by Nissan Chemical Industries, Ltd.).

It is preferred to use the conductive inorganic oxide particle having silicon oxide held on the surface thereof because such a particle particularly effectively reacts with an alkoxysilane compound. The conductive inorganic oxide particle having silicon oxide held thereon can be produced, for example, by a method described in Japanese Patent 2858271 which includes forming a coprecipitate of a tin oxide and antimony oxide hydrate, depositing a silicon compound thereon, fractionation and calcination.

Examples of the commercially available product of the conductive inorganic oxide particle having silicon oxide held thereon include SN-100P (ATO), SNS-10M and FSS-10M, produced by Ishihara Sangyo Kaisha, Ltd.

Examples of the commercially available product of a dispersion of the conductive inorganic oxide particles in an organic solvent include SNS-10M (antimony-doped tin oxide dispersed in methyl ethyl ketone) and FSS-10M (antimony-doped tin oxide dispersed in isopropyl alcohol) produced by Ishihara Sangyo Kaisha, Ltd., Celnax CX-Z401M (zinc antimonate dispersed in methanol) and Celnax CX-Z2001P (zinc antimonate dispersed in isopropyl alcohol) produced by Nissan Chemical Industries, Ltd., ELCOM JX-1001PTV (phosphorus-containing tin oxide dispersed in propylene glycol monomethyl ether) produced by Catalysts & Chemicals Industries Co., Ltd.

### [Organic Solvent]

The organic solvent for use in the curable composition for forming a conductive layer is used as a dispersion medium for dispersing the conductive inorganic oxide particle.

The organic solvent is used in an amount preferably from 20 to 4,000 parts by weight, and more preferably 100 to 1,000 parts by weight, based on 100 parts by weight of the conductive inorganic oxide particles. When the amount of the solvent is less than 20 parts by weight, since the viscosity is too high, a uniform reaction may be hardly conducted in some cases. When the amount of the solvent is more than 4,000 parts by weight, the coating property may deteriorate in some cases.

Examples of the organic solvent include those having a boiling point of 200° C. or lower at, a normal pressure. Specifically, an alcohol, a ketone, an ether, an ester, a hydrocarbon and an amides are used. The solvents may be used individually or in combination of two or more thereof. Among them, an alcohol, a ketone, an ether and an ester are preferred. [0170]

Examples of the alcohol include methanol, ethanol, isopropyl alcohol, isobutanol, n-butanol, tert-butanol, ethoxyethanol, butoxyethanol, diethylene glycol monoethyl ether, benzyl alcohol and phenethyl alcohol. Examples of the ketone include acetone, methyl ethyl ketone, methyl isobutyl ketone and cyclohexanone. Examples of the ether include dibutyl ether and propylene glycol monoethyl ether acetate. Examples of the ester include ethyl acetate, butyl acetate and ethyl lactate. Examples of the hydrocarbon include toluene and xylene. Examples of the amide include formamide, dimethylacetamide and N-methylpyrrolidone.

Among them, for example, isopropyl alcohol, ethoxyethanol, butoxyethanol, diethylene glycol monoethyl ether, methyl ethyl ketone, methyl isobutyl ketone, cyclohexanone, propylene glycol monoethyl ether acetate, butyl acetate and ethyl lactate are preferred.

### (Binder of Conductive Layer)

As the binder of the conductive layer, a curable resin for use in the high refractive index layer, particularly, an ionizing radiation curable polyfunctional monomer or polyfunctional oligomer is preferably used. A crosslinked polymer obtained by reacting a reactive curable resin can also be used as the binder. The crosslinked polymer preferably has an anionic group.

The crosslinked polymer having an anionic group has a structure that the main chain of the polymer having an anionic group is crosslinked. The anionic group has a function of maintaining the dispersion state of the conductive inorganic fine particle. The crosslinked structure has a function of imparting a film-forming property to the polymer to strengthen the conductive layer.

Examples of the polymer main chain include a polyolefin (saturated hydrocarbon), a polyether, a polyurea, a polyurethane, a polyester, a polyamine, a polyamide and a melamine resin. A polyolefin main chain, a polyether main chain, and a polyurea main chain are preferred, a polyolefin main chain and a polyether main chain are more preferred, and a polyolefin main chain is most preferred.

The polyolefin main chain is composed of a saturated hydrocarbon. The polyolefin main chain is obtained, for example, by an addition polymerization reaction of an unsaturated polymerizable group. The polyether main chain is composed of repeating units connected via an ether linkage (—O—). The polyether main chain is obtained, for example, by a ring-opening polymerization reaction of an epoxy group. The polyurea main chain is composed of repeating units connected via a urea linkage (—NH—CO—NH—). The polyurea main chain is obtained, for example, by a polycondensation reaction of an isocyanate group and an amino group. The polyurethane main chain is composed of repeating units connected via a urethane linkage (—NH—CO—O—). The polyurethane main chain is obtained, for example, by a polycondensation reaction of an isocyanate group and a hydroxy group (including an N-methylol group). The polyester main chain is composed of repeating units connected via an ester linkage (—CO—O—). The polyester main chain is obtained, for example, by a polycondensation reaction of a carboxyl group (including an acid halide group) and a hydroxy group (including an N-methylol group). The polyamine main chain is composed of repeating units connected via an imino linkage (—NH—). The polyamine main chain is obtained, for example, by a ring-opening polymerization reaction of an ethyleneimine group. The polyamide main chain is composed of repeating units connected via an amide linkage (—NH—CO—). The polyamide main chain is obtained, for example, by a reaction of an isocyanate group and a carboxyl group (including an acid halide group). The melamine resin main chain is obtained, for example, by a polycondensation reaction of a triazine group (for example, melamine) and an aldehyde (for example, formaldehyde). The main chain of the melamine resin has per se a crosslinked structure.

The anionic group is connected to the polymer main chain directly or via a connecting group. The anionic group is preferably connected to the main chain via a connecting group as a side chain.

Examples of the anionic group include a carboxylic acid group (carboxyl group), a sulfonic acid group (sulfo group), and a phosphoric acid group (phosphono group), and a sulfonic acid group and a phosphoric acid group are preferred.

The anionic group may be in a state of salt. A cation forming the salt with the anionic group is preferably an alkali metal ion. Also, the proton of the anionic group may be dissociated.

The connecting group connecting the anionic group and the polymer main chain is preferably a divalent group selected from —CO—, —O—, an alkylene group, an arylene group and a combination thereof.

The crosslinked structure forms a chemical bond (preferably a covalent bond) between two or more main chains. The crosslinked structure preferably forms a covalent bonding of three or more main chains. The crosslinked structure is preferably composed of a divalent or higher valent group selected from —CO—, —O—, —S—, a nitrogen atom, a phosphorus atom, an aliphatic residue, an aromatic residue and a combination thereof.

The crosslinked polymer having an anionic group is preferably a copolymer comprising a repeating unit having an anionic group and a repeating unit having a crosslinked structure. In the copolymer, the ratio of the repeating unit having an anionic group is preferably from 2 to 96% by weight, more preferably from 4 to 94% by weight, and most preferably from 6 to 92% by weight. The repeating unit may have two or more anionic groups. In the copolymer, the ratio of the repeating unit having a crosslinked structure is preferably from 4 to 98% by weight, more preferably from 6 to 96% by weight, and most preferably from 8 to 94% by weight.

The repeating unit of the crosslinked polymer having an anionic group may have both an anionic group and a crosslinked structure. Also, the crosslinked polymer having an anionic group may contain other repeating unit (a repeating unit having neither an anionic group nor a crosslinked unit).

Other repeating unit includes preferably a repeating unit having an amino group or a quaternary ammonium group and a repeating unit having a benzene ring. The amino group or quaternary ammonium group has a function of maintaining the dispersion state of the inorganic fine particle, similarly to the anionic group. The amino group, quaternary ammonium group and benzene ring exhibit the same effects even when they are contained in the repeating unit having an anion group or the repeating unit having a crosslinked structure.

In the repeating unit having an amino group or a quaternary ammonium group, the amino group or quaternary ammonium group is directly connected to the polymer main chain or connected to the main chain through a connecting group. The amino group or quaternary ammonium group is preferably connected to the main chain through a connecting group as a side chain. The amino group or quaternary ammonium group is preferably a secondary amino group, a tertiary amino group or a quaternary ammonium group, and more preferably a tertiary amino group or a quaternary ammonium group. A group connected to the nitrogen atom of the secondary amino group, tertiary amino group or quaternary ammonium group is preferably an alkyl group, more preferably an alkyl group having from 1 to 12 carbon atoms, and still more preferably an alkyl group having from 1 to 6 carbon atoms. The counter ion of the quaternary ammonium group is preferably a halide ion. The connecting group connecting the amino group or quaternary ammonium group and the polymer main chain is preferably a divalent group selected from —CO—, —NH—, —O—, an alkylene group, an arylene group and a combination thereof. In the case where the crosslinked polymer having an anionic group contains a repeating unit having an amino group or a quaternary ammonium group, the ratio of the repeating unit is preferably from 0.06 to 32% by weight, more preferably from 0.08 to 30% by weight, and most preferably from 0.1 to 28% by weight.

The above-described binder may also be used in combination with a reactive organosilicon compound described, for example, in JP-A-2003-39586. The reactive organosilicon compound is used in an amount of 10 to 70% by weight based on the ionizing radiation curable resin as the binder. The reactive organosilicon compound is preferably the organosilane compound represented by formula (I) described above, particularly preferably an organosilane compound represented by formula (II) described above, and the conductive layer can be formed by using only the compound as the resin component.

### [Solvent]

The solvent which is used to dissolve the coating composition for forming any of the above-described layers is not particularly limited, and an alcohol solvent and a ketone solvent are preferably used. Specific examples thereof include acetone, methyl ethyl ketone, 2-pentanone, 3-pentanone, 2-hexane, 2-heptanone, 4-heptanone, methyl isopropyl ketone, ethyl isopropyl ketone, diisopropyl ketone, methyl isobutyl ketone, methyl tert-butyl ketone, diacetyl, acetylacetone, acetonylacetone, diacetone alcohol, mesityl oxide, chloroacetone, cyclopentanone, cyclohexanone and acetophenone. Among them, methyl ethyl ketone and methyl isobutyl ketone are preferred. The solvents may be used individually or in combination thereof at an appropriate mixing ratio.

As an auxiliary solvent, an ester solvent, for example, propylene glycol monomethyl ether acetate or a fluorine-based solvent, for example, a fluorine-based alcohol may be appropriately used. The solvents may be used individually or in combination thereof at an appropriate mixing ratio.

### [Coating Composition]

The coating composition for forming an antireflective film according to the invention contains (A) a fluorine-containing antifouling agent having a weight average molecular weight (Mw) less than 10,000, a polymerizable unsaturated group and a structure represented by formula (F), (B) a polyfunctional monomer having a polymerizable unsaturated group, (C) an inorganic fine particle, and if desired, (D) a photopolymerization initiator. The content of component (A) is 1% by weight or more and less than 25% by weight, preferably from 1 to 15% by weight, and most preferably 1 to 10% by weight, based on the total solid content of the coating composition. The content of component (B) is preferably from 5 to 90% by weight, more preferably from 20 to 80% by weight, and most preferably from 30 to 65% by weight, based on the total solid content of the coating composition. The content of component (C) is preferably from 10 to 70% by weight, more preferably from 20 to 60% by weight, and most preferably from 35 to 55% by weight, based on the total solid content of the coating composition. The content of component (D) is preferably from 1 to 5% by weight, based on the total solid content of the coating composition. When the content of component (A) is less than 1% by weight, the effect of improving the antifouling property is not obtained, whereas when it is 25% by weight or more, the transfer property degrades so that continuous production of the antireflective film in the form of a long film can not be conducted. Also, due to the blurring the degradation of surface state and deterioration of scratch resistance may be caused. When the content of component (C) is less than 10% by weight, the surface migration of the fluorine-containing antifouling agent decreases so that the sufficient antifouling property can not be obtained and in addition, the effect of improving the scratch resistance can not be obtained. When it exceeds 70% by weight, the deterioration of surface state, for example, whitening of the layer is caused.

The coating composition further contains a solvent. In the case of using a solvent, the solvent is preferably used so that the solid content concentration in the coating composition is from 0.1 to 20% by weight, more preferably from 1 to 15% by weight, and most preferably from 1 to 10% by weight.

### (Coating Process)

The antireflective film according to the invention can be formed by the following method, but the invention should not be construed as being limited thereto. First, a coating composition containing components for forming each layer is prepared. Then, the coating composition is coated on a transparent support by a dip coating method, an air knife coating method, a curtain coating method, a roller coating method, a wire bar coating method, a gravure coating method or a die coating method followed by heating and drying. A microgravure coating method, a wire bar coating method and a die coating method (see, U.S. Pat. No. 2,681,294 and JP-A-2006-122889) are more preferred, and a die coating method is particularly preferred.

After the coating, the layer formed from the coating composition is cured by irradiating light or heating, whereby a low refractive index layer is formed. If desired, an optical layer (a layer constituting the antireflective film, which is described hereinbefore, for example, a hardcoat layer, an antiglare layer, a medium refractive index layer or a high refractive index layer) may be previously coated on a transparent support, and a low refractive index layer is formed thereon. Thus, the antireflective film according to the invention is obtained.

### [Protective Film for Polarizing Plate]

In the case of using the antireflective film as a surface protective film of a polarizing film (protective film for polarizing plate), the adhesion property to the polarizing film comprising a polyvinyl alcohol as the main component can be improved by hydrophilizing the surface of the transparent support opposite the side having the thin-film layer, that is, the surface on the side to be laminated with the polarizing film.

It is also preferred that of the two protective films of the polarizer, the film other than the antireflective film is an optical compensation film having an optical compensation layer comprising an optically anisotropic layer. The optical compensation film (retardation film) can improve the viewing angle characteristics on the liquid crystal display screen.

Although a known optical compensation film can be used, an optical compensation film described in JP-A-2001-100042 is preferred from the standpoint of enlarging the viewing angle, [0185]

In the case of using the antireflective film as a. surface protective film of a polarizing film (protective film for polarizing plate), as the transparent support, a triacetyl cellulose film is particularly preferably used.

A method of preparing the protective film for a polarizing plate according to the invention includes three methods, that is, (1) a method of applying each layer constituting the antireflective film (layers of the antireflective film exclusive of the transparent support, for example, a high refractive index layer, a low refractive index layer, preferably a hardcoat layer, hereinafter also referred to as “antireflective layer”) on one surface of a transparent support previously subjected to a saponification treatment, (2) a method of applying the antireflective layer on one surface of a transparent support and subjecting the side to be laminated with a polarizing film or both surfaces to a saponification treatment and (3) a method of applying a part of the antireflective layers on one surface of a transparent support, subjecting the side to be laminated with a polarizing film or both surfaces to a saponification treatment and then applying the remaining layers. In the method of (1), the surface where the antireflective layer is coated is also hydrophilized and the adhesion property between the transparent support and the antireflective layer can be hardly ensured and thus, the method of (2) is particularly preferred.

### [Polarizing Plate]

The polarizing plate according to the invention is described below.

The polarizing plate according to the invention is a polarizing plate comprising a polarizing film sandwiched between two surface protective films, wherein the antireflective film according to the invention is used as one of the surface protective films.

One preferred embodiment of the polarizing plate according to the invention is described below. According to the preferred embodiment of the polarizing plate, at least one of the protective films (protective films for polarizing plate) of the polarizing film is the antireflective film according to the invention. Specifically, the transparent support of the antireflective film is adhered to a polarizing film, if desired, through an adhesive layer comprising a polyvinyl alcohol and a protective film is also provided on another side of the polarizing film. On the surface of another protective film opposite the polarizing film, an adhesive layer may be provided.

By using the antireflective film according to the invention as the protective film for polarizing plate, a polarizing plate having an antireflective function excellent in physical strength and light resistance can be produced so that a great reduction in the cost and thinning of the display device can be achieved.

Moreover, the polarizing plate according to the invention may also have an optical compensation function. In this case, it is preferred that the antireflective film is used only for one surface side, that is, either the front surface side or the rear surface side, of two surface protective films and the surface protective film on the surface of the polarizing plate opposite the side having the antireflective film is an optical compensation film.

By producing a polarizing plate wherein the antireflective film according to the invention is used as one protective film for polarizing plate and an optical compensation film having optical anisotropy is used as another protective film for polarizing film, the bright-room contrast and the up/down left/right viewing angle of liquid crystal display device can be more improved.

Among the constructions of the antireflective film according to the invention, particularly, the construction of the antireflective film shown below is preferred, because the reflection color is uniform and neutral with low reflectivity, the excellent antifouling property is achieved wherein a fingerprint or sebum, when attached, is easily wiped off and hardly noticeable, and the scratch resistance is also excellent.

### Constitution:

Transparent substrate: Tricellulose acetate film (refractive index: 1.49, film thickness: 80 μm)
Hardcoat layer: Polyfunctional monomer having a polymerizable unsaturated group, a silica sol, a photopolymerization initiator (refractive index: 1.49, film thickness: 10 μm)
Medium refractive index layer: Polyfunctional monomer having a polymerizable unsaturated group, a zirconium oxide fine particle, a photopolymerization initiator (refractive index: 1.62, film thickness 60 nm,)
High refractive index layer: Polyfunctional monomer having a polymerizable unsaturated group, a zirconium oxide fine particle, a photopolymerization initiator (refractive index: 1.72, film thickness 110 nm)
Low refractive index layer: Fluorine-containing copolymer having a polymerizable unsaturated group, a hollow silica fine particle, a polyfunctional monomer having a polymerizable unsaturated group (fluorine-containing compound and non-fluorine-containing compound), a fluorine-containing antifouling agent having a polymerizable unsaturated group, a photopolymerization initiator (refractive index: 1.36, film thickness 90 nm)

By using the antireflective film or polarizing plate according to the invention as a display of an image display device, the excellent visibility can be achieved.

### EXAMPLES

The present invention will be described in more detail with reference to the following examples, but the invention should not be construed as being limited thereto.

### Example 1

### Production of Antireflective Film

Preparation of a Coating Solution for Forming Each Layer and Formation of Each layer were conducted in the manner shown below to produce Antireflective film Nos. 1 to 30.

### (Preparation of Coating Solution a for Hardcoat Layer)

The composition shown below was charged into a mixing tank and the mixture was stirred.

Based on 900 parts by weight of methyl ethyl ketone (MEK), 100 parts by weight of cyclohexanone, 750 parts by weight of partially caprolactone-modified polyfunctional acrylate (DPCA-20, produced by Nippon Kayaku Co., Ltd.), 200 parts by weight of a silica sol (MIRK-ST, produced by Nissan Chemical Industries, Ltd.) and 50 parts by weight of a photopolymerization initiator (Irgacure 184, produced by Ciba Japan K.K.).

After the stirring, the mixture was filtered through a polypropylene filter having a pore size of 0.4 μm to prepare Coating solution A for hardcoat layer.

### (Preparation of Coating Solution B for Hardcoat Layer)

To a vessel were added 14.1 parts by weight of Solvent dispersion A of conductive compound shown below, 37.7 parts by weight of KAYARAD DPHA (mixture of dipentaerythritol pentaacrylate and dipentaerythritol hexaacrylate, produced by Nippon Kayaku Co., Ltd.), 27.2 parts by weight of propylene glycol monomethyl ether (produced by Wako Pure Chemical Industries, Ltd.), 2.4 parts by weight of dimethyl carbonate (produced by Tokyo Chemical Industry Co., Ltd.), 0.97 parts by weight of isopropyl alcohol (produced by Wako Pure Chemical Industries, Ltd.) and 1.3 parts by weight of a photopolymerization initiator (Irgacure 127, produced by Ciba Japan K.K.), and the mixture was stirred and filtered through a polypropylene filter having a pore size of 1.0 μm to prepare Coating solution B for hardcoat layer.

### Solvent Dispersion A:

Solution containing 30.7 parts by weight (solid content) of IP-9 described hereinbefore in a mixed solvent of propylene glycol monomethyl ether and isopropyl alcohol (30/70 by weight ratio)

### (Preparation of Coating Solution C for Hardcoat Layer)

The composition shown below was charged into a mixing tank and the mixture was stirred.

Based on a mixed solvent of 72.6 parts by weight of methyl isobutyl ketone (MIBK) and 32.5 parts by weight of MEK, 65 parts by weight of PET-30 (mixture of pentaerythritol triacrylate and pentaerythritol tetraacrylate, produced by Nippon Kayaku Co., Ltd.), 4.3 parts by weight of a photopolymerization initiator (Irgacure 184, produced by Ciba Japan K.K.), 52.5 parts by weight of crosslinked acrylic particle (30% by weight MIBK dispersion prepared by dispersing a crosslinked acrylic particle having an average particle size of 8.0 μM (produced by Soken Chemical and Engineering Co., Ltd.) by a Polytron dispersing machine at 10,000 rpm for 20 minutes), 52.6 parts by weight of crosslinked acrylic/styrene particle (30% by weight MIBK dispersion prepared by dispersing a crosslinked acrylic/styrene particle having an average particle size of 8.0 μm (produced by Sekisui Plastics Co., Ltd.) by a Polytron dispersing machine at 10,000 rpm for 20 minutes), 0.2 parts by weight of SP-13 (10% by weight MEKI solution of fluorine-based surfactant shown below) and 0.5 parts by weight of CAB (cellulose acetate butyrate).

After the stirring, the mixture was filtered through a polypropylene filter having a pore size of 30 μm to prepare Coating solution C for hardcoat layer.

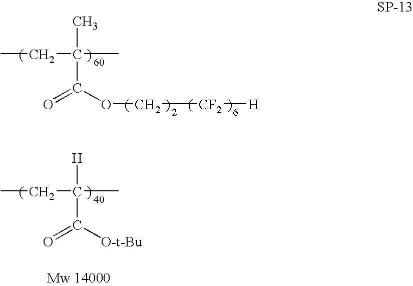

A refractive index of a cured layer formed from each coating solution for hardcoat layer was 1.522.

### (Preparation of Coating Solution A for Medium Refractive Index Layer)

5.3 Pares by weight of rutile type titanium oxide (MT-500HDM, produced by Tayca Corp.), 1.1 part by weight of Disperbyk 163 (produced by BYK-Chemie), 2.1 part by weight of pentaerythritol triacrylate (PETA), 0.11 part by weight of Irgacure 184 (produced by Ciba Japan K.K.), 71.6 pares by weight of dipentaerythritol pentaacrylate (SR399E, produced by Nippon Kayaku Co., Ltd.) and 20 pares by weight of methyl isobutyl ketone (MIBK) were mixed to prepare Coating solution A for medium refractive index layer. A refractive index of a coated film formed from Coating solution A for medium refractive index layer was 1.76.

### (Preparation of Coating Solution B for Medium Refractive Index Layer)

To 20.0 parts by weight of a commercially available conductive fine particle ATO “antimony-doped tin oxide T-1” (specific surface area: 80 m²/g, produced by Mitsubishi Material Corp.) were added 6.0 Parts by weight of Dispersant (B-1) having an anionic group and a methacryloyl group shown below and 74 parts by weight of methyl isobutyl ketone, and the mixture was stirred.

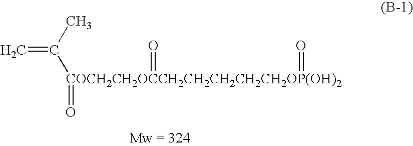

Using a media disperser (using a zirconia bead having a diameter of 0.1 mm), the ATO particles in the solution described above were dispersed. A weight average particle size of the ATO particle in the dispersion was evaluated by a light scattering method and as a result, it was found to be 55 nm. Thus, an ATO dispersion was produced.

To 100 parts by weight of the ATO dispersion described above were added 6 parts by weight of a mixture of dipentaerythritol pentaacrylate and dipentaerythritol hexaacrylate (DPHA, produced by Nippon Kayaku Co., Ltd.) and 0.8 parts by weight of a polymerization initiator (Irgacure 184, produced by Ciba Japan K.K.), and the mixture was stirred to prepare Coating solution B for medium refractive index layer. A refractive index of a coated film formed from Coating solution B for medium refractive index layer was 1.62.

(Preparation of Coating Solution A for high Refractive Index Layer)

18.7 Pares by weight of rutile type titanium oxide (MT-500HDM, produced by Tayca Corp.), 3.7 parts by weight of Disperbyk 163 (produced by BYK-Chemie), 7.5 parts by weight of pentaerythritol triacrylate (PETA), 0.37 parts by weight of Irgacure 184 (produced by Ciba Japan K.K.) and 70 pares by weight of methyl isobutyl ketone (MIBK) were mixed to prepare Coating solution A for high refractive index layer. A refractive index of a coated film formed from Coating solution A for high refractive index layer was 1.90.

(Preparation of Coating Solution B for high Refractive Index Layer)

17.5 Pares by weight of rutile type titanium oxide (MT-500HDM, produced by Tayca Corp.), 3.6 parts by weight of Disperbyk 163 (produced by BYK-Chemie), 13.2 parts by weight of pentaerythritol triacrylate (PETA), 0.36 parts by weight of Irgacure 184 (produced by Ciba Japan K.K.) and 65.4 pares by weight of methyl isobutyl ketone (MIBK) were mixed to prepare Coating solution B for high refractive index layer. A refractive index of a coated film formed from Coating solution B for high refractive index layer was 1.70.

### (Preparation of Coating Solution for Low Refractive Index Layer)

### (Preparation of Hollow Silica Dispersion A-1)

Using a method for preparing Dispersion A-1 described in JP-A-2007-298974 while adjusting conditions, Hollow silica dispersion A-1 was prepared. An average particle size, shell thickness and refractive index of the silica particle were 60 nm, 10 nm and 1.31, respectively.

### (Preparation of Hollow Silica Dispersion B-1)

To 500 parts by weight of Hollow silica dispersion A-1 were added 30 parts by weight of acryloyloxypropyltrimethoxysilane and 1.51 part by weight of diisopropoxyaluminum ethyl acetate, and after mixing 9 parts by weight of ion-exchanged water was added thereto. The mixture was reacted at 60° C. for 8 hours, cooled to room temperature and 1.8 parts by weight of acetyl acetone was added thereto. Then, solvent replacement by reduced-pressure distillation was conducted under a pressure of 30 Ton while adding cyclohexanone to keep the silica content almost constant and finally the concentration was adjusted to obtain Dispersion B-1 having a solid content concentration of 18.2% by weight. The amount of IPA remaining in the resulting dispersion was analyzed by gas chromatography and found to be 0.5% or less. Also, Dispersion B-1 was spin-coated onto a quartz substrate and then a surface energy of the hollow silica particle was measured and found to be 55 mN/m.

### (Preparation of Hollow Silica Dispersion B-2)

Hollow silica dispersion B-2 was prepared in the same manner as the preparation of Hollow silica dispersion B-1 except for using 3,3,3-trifluoro-n-propyltrimethoxysilane (KBM-7103, produced by Shin-Etsu Chemical Co., Ltd.) in place of the acryloyloxypropyltrimethoxysilane. Dispersion B-2 thus obtained was spin-coated onto a quartz substrate and then a surface energy of the hollow silica particle was measured and found to be 40 mN/m.

### (Preparation of Hollow Silica Dispersion A-2)

Using the same method as in the preparation of Hollow silica dispersion A-1 while adjusting conditions, Hollow silica dispersion A-2 was prepared. An average particle size, shell thickness and refractive index of the silica particle were 30 nm, 5 nm and 1.31, respectively.

### (Preparation of Hollow Silica Dispersion B-3)

Hollow silica dispersion B-3 was prepared in the same manner as the preparation of Hollow silica dispersion B-1 except for using Hollow silica dispersion A-2 in place of Hollow silica dispersion A-1. Dispersion B-3 thus obtained was spin-coated onto a quartz substrate and then a surface energy of the hollow silica particle was measured and found to be 58 mN/m.

Each of the components was mixed as shown in Table 1 below and dissolved in MEK to prepare Coating solutions Ln1 to Ln24 for low refractive index layer each having a solid content concentration of 5% by weight. Hollow silica dispersions B-1 to B-3 were used in such a way that the amount of hollow silica included is adjusted to the value described in Table 1, respectively.

TABLE 1

| | Component and Amount | | | | | | | | | |
|---|---|---|---|---|---|---|---|---|---|---|
| | (% by weight based on total solid content) | | | | | | | | | |
| Coating | Polyfunctional | | Antifouling | | | | | | | |
| Solution | Monomer | | Agent | | Initiator | | Fine Particle | | Refractive | |
| No. | Kind | Amount | Kind | Amount | Kind | Amount | Kind | Amount | Index | Remarks |
| Ln 1 | PETA | 37 | — | 0 | Irg. 907 | 3 | Hollow Silica B-1 | 60 | 1.36 | Comparative |
| | (tri-function) | | | | | | | | | Example |
| Ln 2 | PETA | 34 | d-4 | 3 | Irg. 907 | 3 | Hollow Silica B-1 | 60 | 1.36 | Invention |
| | (tri-function) | | Mw≈1,600 | | | | | | | |
| Ln 3 | PETA | 32 | d-4 | 5 | Irg. 907 | 3 | Hollow Silica B-1 | 60 | 1.36 | Invention |
| | (tri-function) | | Mw≈1,600 | | | | | | | |
| Ln 4 | PETA | 27 | d-4 | 10 | Irg. 907 | 3 | Hollow Silica B-1 | 60 | 1.36 | Invention |
| | (tri-function) | | Mw≈1,600 | | | | | | | |
| Ln 5 | PETA | 17 | d-4 | 20 | Irg. 907 | 3 | Hollow Silica B-1 | 60 | 1.36 | Invention |
| | (tri-function) | | Mw≈1,600 | | | | | | | |
| Ln 6 | PETA | 14 | d-4 | 23 | Irg. 907 | 3 | Hollow Silica B-1 | 60 | 1.36 | Invention |
| | (tri-function) | | Mw≈1,600 | | | | | | | |
| Ln 7 | PETA | 7 | d-4 | 30 | Irg. 907 | 3 | Hollow Silica B-1 | 60 | 1.36 | Comparative |
| | (tri-function) | | Mw≈1,600 | | | | | | | Example |
| Ln 8 | PETA | 32 | b-7 | 5 | Irg. 907 | 3 | Hollow Silica B-1 | 60 | 1.36 | Invention |
| | (tri-function) | | Mw = 378 | | | | | | | |
| Ln 9 | PETA | 7 | a-6 | 30 | Irg. 907 | 3 | Hollow Silica B-1 | 60 | 1.36 | Comparative |
| | (tri-function) | | Mw = 460 | | | | | | | Example |
| Ln 10 | PETA | 32 | a-6 | 5 | Irg. 907 | 3 | Hollow Silica B-1 | 60 | 1.36 | Invention |
| | (tri-function) | | Mw = 460 | | | | | | | |
| Ln 11 | PETA | 32 | MF-1(n≈7) | 5 | Irg. 907 | 3 | Hollow Silica B-1 | 60 | 1.36 | Invention |
| | (tri-function) | | Mw = 1,550 | | | | | | | |
| Ln 12 | PETA | 32 | d-5 | 5 | Irg. 907 | 3 | Hollow Silica B-1 | 60 | 1.36 | Invention |
| | (tri-function) | | Mw≈1 ,800 | | | | | | | |
| Ln 13 | PETA | 32 | MF-1(n≈20) | 5 | Irg. 907 | 3 | Hollow Silica B-1 | 60 | 1.36 | Invention |
| | (tri-function) | | Mw = 3,770 | | | | | | | |
| Ln 14 | PETA | 32 | b-6 | 5 | Irg. 907 | 3 | Hollow Silica B-1 | 60 | 1.36 | Invention |
| | (tri-function) | | Mw≈7,500 | | | | | | | |
| Ln 15 | PETA | 32 | b-6 | 5 | Irg. 907 | 3 | Hollow Silica B-1 | 60 | 1.36 | Invention |
| | (tri-function) | | Mw≈15,000 | | | | | | | |
| Ln 16 | PETA | 32 | F3035 | 5 | Irg. 907 | 3 | Hollow Silica B-1 | 60 | 1.36 | Comparative |
| | (tri-function) | | | | | | | | | Example |
| Ln 17 | PETA | 32 | X22-164C | 5 | Irg. 907 | 3 | Hollow Silica B-1 | 60 | 1.36 | Comparative |
| | (tri-function) | | | | | | | | | Example |
| Ln 18 | PETA | 32 | d-4 | 5 | Irg. 907 | 3 | Hollow Silica B-1 | 60 | 1.36 | Invention |
| | (tri-function) | | Mw≈1,600 | | | | | | | |
| Ln 19 | PETA | 32 | d-4 | 5 | Irg. 907 | 3 | Hollow Silica B-1 | 60 | 1.36 | Invention |
| | (tri-function) | | Mw≈1,600 | | | | | | | |
| Ln 20 | PETA | 32 | d-4 | 5 | Irg. 907 | 3 | Silica | 60 | 1.45 | Invention |
| | (tri-function) | | Mw≈1,600 | | | | | | | |
| Ln 21 | PETA | 92 | d-4 | 5 | Irg. 907 | 3 | None | 0 | 1.56 | Comparative |
| | (tri-function) | | Mw≈1,600 | | | | | | | Example |
| Ln 22 | PETA | 77 | d-4 | 20 | Irg. 907 | 3 | None | 0 | 1.54 | Comparative |
| | (tri-function) | | Mw≈1,600 | | | | | | | Example |
| Ln 23 | DPHA | 32 | d-4 | 5 | Irg. 907 | 3 | Hollow Silica B-1 | 60 | 1.36 | Invention |
| | | | Mw≈1,600 | | | | | | | |
| Ln 24 | PETA | 32 | d-4 | 5 | Irg. 907 | 3 | Hollow Silica B-1 | 60 | 1.36 | Invention |
| | (tetra-function) | | Mw≈1,600 | | | | | | | |

The compounds used are shown below.

PETA (tri-function): Pentaerythritol triacrylate
PETA (tetra-function): Pentaerythritol tetraacrylate
DPHA: Mixture of dipentaerythritol pentaacrylate and dipentaerythritol hexaacrylate (produced by Nippon Kayaku Co., Ltd.)
(d-4): Perfluoropolyether-containing acrylate described hereinbefore
(d-5): Perfluoropolyether-containing acrylate described hereinbefore

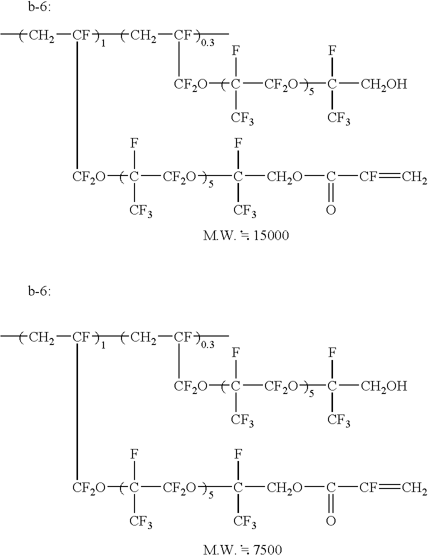

In the above antifouling agent b-6, the recited ratio of repeating units is a molar ratio of each unit

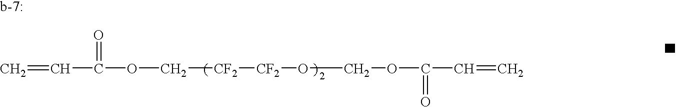

a-6: Fluorine-containing acrylate described hereinbefore
MF-1: Fluorine-containing unsaturated compound described in Example of WO 2003/022906 shown below.

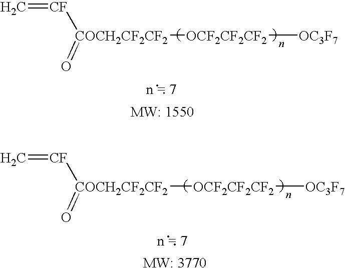

F3035: Fluorine-containing polymer not having a polymerizable unsaturated group (produced by NOF Corp).
X-22-164C: Reactive silicone (produced by Shin-Etsu Chemical Co., Ltd.)
Irgacure (Irg.) 907: Polymerization initiator (produced by Ciba Japan K.K.)
Silica: MEK-ST-L (silica sol having an average particle size of 45 nm, produced by Nissan Chemical Industries, Ltd.)

The surface energies of the antifouling agents used at their single film are shown below, respectively.

(d-4) (Mw: 1,600): 13 mN/m
(d-5) (Mw: 1,800): 13 mN/m
(MF-1) (Mw: 1,550): 14 mN/m
(MF-1) (Mw: 3,770): 13 mN/m
(b-6) (Mw: 7,500): 12 mN/m
(b-6) (Mw: 15,000): 12 mN/m
(b-7) (Mw: 378): 15 mN/m
(a-6): 19 mN/m
F3035: 18 mN/m
X-22-164C: 24 mN/m

The surface energy was measured in the following manner. The antifouling agent was spin-coated on a quartz substrate and dried, when a solvent was included, to form a film. Using a contact angle meter (“CA-X”, produced by Kyowa Interface Science Co., Ltd.) under dry conditions (20° C./65% RH), a droplet having a diameter of 1.0 mm of pure water as a liquid was made on the tip of stylus and brought into contact with the surface of the film to form the droplet on the film. The angle formed between the tangent line to the liquid droplet surface and the film surface on the side including the liquid droplet at the end point where the film was brought into contact with the liquid was measured to determine a contact angle. Further, using methylene iodide in place of pure water, the contact angle was measured, and the surface free energy was determined using to the equations shown below.

The surface free energy (γs^{v}, unit: mN/m) was defined by the sum of γs^{d} and γs^{h} (γs^{V}=γs^{d}+γs^{h}) which are obtained by using the experimentally determined contact angles of pure water H₂O and methylene iodide CH₂I₂, θ_{H2O} and θ_{CH212}, on the film described above and the following simultaneous equations a) and b) with reference to D. K. Owens, J. Appl. Polym. Sci., 13, 1741 (1969).

1+cos θ_{H2O}=2√γs^{d}(√γ_{H2O}^{d}/γ_{H2O}^{v})+2√γs^{h}(√γ_{H2O}^{h}/γ_{H2O}^{v}) a)

1+cos θ_{CH212}=2√γs^{d}(√γ_{CH212}^{d}/γ_{CH212}^{v})+2√γs^{h}(√γ_{CH212}^{h}/γ_{CH212}^{v}) b)

γ_{H2O}^{d}=21.8, γ_{H2O}^{h}=51.0, γ_{H2O}^{v}=72.8

γ_{CH212}^{d}=49.5, γ_{CH212}^{h}=1.3, γ_{CH212}^{v}=50.8

### (Production of Hardcoat Layer a)

On a triacetyl cellulose film (TD80UF, produced by Fujifilm Corp., refractive index: 1.48) having a thickness of 80 μm as a transparent substrate was coated Coating solution A for hardcoat layer described above using a gravure coater and dried at 100° C. Then, the coated layer was cured by irradiating an ultraviolet ray at an illuminance of 400 mW/cm² and an irradiation dose of 150 mJ/cm² using an air-cooled metal halide lamp (produced by Eye Graphics Co., Ltd.) of 160 W/em while purging with nitrogen so as to give an atmosphere having an oxygen concentration of 1.0% by volume or less, whereby Hardcoat layer A having a thickness of 12 μm was formed.

On Hardcoat Layer A were coated the coating solution for medium refractive index layer, the coating solution for high refractive index layer and the coating solution for low refractive index layer each prepared to have a desired refractive index using a gravure coater. With respect to Sample Nos. 1 to 24, each coating solution for low refractive index layer shown in Table 2 was coated on Hardcoat Layer A and cured to form a low refractive index layer having a thickness of 94 nm. With respect to Sample Nos. 25 to 30, respective layers shown in Table 3 were formed. The refractive index of each layer was measured by Multi-wavelength Abbe Refractometer DR-M2 (produced by ATAGO Co., Ltd.) after applying the coating solution for each layer on a glass plate so as to have a thickness of about 4 μm. A refractive index measured using a filter, “Interference Filter 546(e) nm for DR-M2, M4, RE-3523”, was employed as the refractive index at a wavelength of 550 nm.

The thickness of each layer was determined using “Reflective Film Thickness Monitor FE-3000” (produced by Otsuka Electronics Co., Ltd.) after laminating the medium refractive index layer, the high refractive index layer and the low refractive index layer. As the refractive index of each layer in the determination, the value obtained by the Abbe Refractometer was used.

The drying conditions of the medium refractive index layer were 90° C. and 30 seconds; and the ultraviolet ray curing conditions were such that an air-cooled metal halide lamp (produced by Eye Graphics Co., Ltd.) of 180 W/cm was used at an illuminance of 300 mW/cm² and an irradiation dose of 240 mJ/cm² while purging with nitrogen so as to give an atmosphere having an oxygen concentration of 1.0% by volume or less.

The drying conditions of the high refractive index layer were 90° C. and 30 seconds, and the ultraviolet ray curing conditions were such that an air-cooled metal halide lamp (produced by Eye Graphics Co., Ltd.) of 240 W/cm was used at an illuminance of 300 mW/cm² and an irradiation dose of 240 mJ/cm² while purging with nitrogen to give an atmosphere having an oxygen concentration of 1.0% by volume or less.

### (Production of Low Refractive Index Layer)

The drying conditions of the low refractive index layer were 90° C. and 30 seconds, and the ultraviolet ray curing conditions were such that an air-cooled metal halide lamp (produced by Eye Graphics Co., Ltd.) of 240 W/cm was used at an illuminance of 600 mW/cm² and an irradiation dose of 600 mJ/cm² while purging with nitrogen to give an atmosphere having an oxygen concentration of 0.1% by volume or less.

### (Evaluation of Antireflective Film)

Various performances of the antireflective film were evaluated according to the methods described below. The results obtained are shown in Tables 2 and 3. (Observation of surface and measurement of surface roughness)

The sea-island structure was observed by an optical microscope and an atomic force microscope (AFM, STA-400, produced by SID. The surface roughness (Ra) was measured according to JIS (1982) using the AFM image obtained in an area of 10×10 μm.

### (Steel Wool Scratch Resistance)

The steel wool (SW) scratch resistance was evaluated by conducting a rubbing test under the conditions shown below using a rubbing tester.

Environmental conditions for evaluation: 25° C. 60% RH

Rubbing material: Steel wool (Grade No. 0000, produced by Nihon Steel Wool Co., Ltd.) wound around the rubbing tip (1×1 cm) of the tester in contact with the sample and fixed by a band

Moving distance (one way): 13 cm

Rubbing speed: 13 cm/sec

Load: 500 g/cm²

Contact area at the tip: 1×1 cm

Number of rubbing: 10 reciprocations

To the rear side of the sample of antireflective film after the rubbing was applied oily black ink and the scratch mark in the rubbed portion was visually observed with reflection light and evaluated according to the criteria shown below.

A: No scratch mark is found even when observed extremely carefully.

B: Slight weak scratch mark is found when observed extremely carefully.

C: Weak scratch mark is found.

D: Scratch mark of medium degree is found.

E: Scratch mark is recognizable at a glance.

### (Fingerprint Wipe-Off Property)

Oily black ink was applied to the rear side of the sample of antireflective film, and a finger was pressed on the coated surface (surface of the low refractive index layer) thereby attaching a fingerprint. The fingerprint attached was wiped off with ten reciprocations with tissue paper, and the remaining trace of the fingerprint attached was observed and evaluated according to the criteria shown below.

A: No trace of the attached fingerprint is completely found.
B: A small trace of the attached fingerprint is found, but is not bothersome.
C: The trace of the attached fingerprint is found and is bothersome.
D: The wipe-off trace of the fingerprint can be clearly visible and is bothersome.

### (Transfer Property)

A front side (side of the low refractive index layer) of the sample of antireflective film was brought into contact with a triacetyl cellulose film (TD80UF, produced by Fujifilm Corp.) used as the transparent substrate film and the resulting laminate was allowed to stand under the conditions of 25° C. and 60% RH for 24 hours while applying a load of 2 kg/cm². Then, the sample was removed from the substrate film, and the fluorine atom amount transferred onto the substrate film was measured by an X-ray photoelectron analyzer (XPS). The transfer property was evaluated using a ratio (F/C) of the amount of fluorine atom detected to the amount of carbon atom detected according to the criteria shown below.

A: F/C is less than 1.5.
B: F/C is 1.5 or more.

### (Measurement of Surface Resistance Value)

The samples of all antireflective films were allowed to stand under the conditions of 25° C. and 60% RH for 2 hours and then, the surface resistance value (SR) was measured by a circular electrode method under the same conditions. The surface resistance value is shown as its logarithmic value (log SR).

### (Dust Attachment Property)

The transparent substrate film side of the antireflective film was laminated on a CRT surface and the device was used for 24 hours in a room having from 100 to 2,000,000 particles of dust of 0.5 μm or more and tissue paper scraps per 1 ft³ (cubic feet). The number of particles of dust and the number of the tissue paper scrapes attached per 100 cm² of the antireflective film were measured and the average value thereof was determined to evaluate the dust attachment property. Specifically, the case where the average value was less than 20 pieces was ranked A, the case where the average value was from 20 to 49 pieces was ranked B, the case where the average value was from 50 to 199 pieces was ranked C, and the case where the average value was 200 pieces or more was ranked D.

### (Specular Reflectivity, Tint, and Color Difference Due to Fluctuation in Film Thickness)

The antireflection property can be evaluated by mounting an adapter ARV-474 on a spectrophotometer V-550 (produced by JASCO Corp.), measuring the specular reflectivity for the outgoing angle of 5° at an incident angle of 5° in the wavelength region of 380 to 780 nm, and calculating the average reflectivity at 450 to 650 nm. Further, the tint of reflected light can be evaluated by calculating from the reflection spectrum measured, the L*, a* and b* values of the CIE1976 L*a*b* color space which are values indicating the tint of regularly reflected light for incident light at 5° of a CIE standard illuminant D65. The tint (L*′, a*′, b*′) of the reflected light when the thickness of an arbitrary layer of the low refractive index layer, high refractive index layer and medium refractive index layer was changed by 2.5% was measured, the color difference ΔE from the tint (L*, a*, b*) of reflected light at a designed film thickness was determined, and the value giving the maximum color difference was calculated to evaluate the color difference due to the fluctuation in film thickness.

ΔE={(L*−L*′)²+(a*−a*′)²+(b*−b*′)²}^{1/2}

### (Surface Energy)

The surface energy of the antireflective film was measured according to the method described in the measurement of the surface energy of the single film of the antifouling agent above.

TABLE 2

| | Performances | | | | | | | | |
|---|---|---|---|---|---|---|---|---|---|
| | | | Steel Wool | Sea-Island | | | | Dust | |
| Sample | Fingerprint | Transfer | Scratch | Structure | | Surface | Log | Attachment | |
| No. | Wipe-Off Property | Property | Resistance | Microscope | Ra | Energy | SR | Property | Remarks |
| 1 | D | A | D | Absent | <3.0 nm | 48 mN/m | >14 | B | Comparative |
| | | | | | | | | | Example |
| 2 | A | A | B | Absent | <3.0 nm | 20 mN/m | >14 | C | Invention |
| 3 | A | A | A | Absent | <3.0 nm | 15 mN/m | >14 | C | Invention |
| 4 | A | A | A | Absent | <3.0 nm | 14 mN/m | >14 | C | Invention |
| 5 | A | A | B | Absent | <3.0 nm | 14 mN/m | >14 | D | Invention |
| 6 | A | A | B | Absent | <3.0 nm | 14 mN/m | >14 | D | Invention |
| 7 | A | B | B | Deposited | 15 nm | 17 mN/m | >14 | D | Comparative |
| | | | | | | | | | Example |
| 8 | C | A | C | Absent | <3.0 nm | 20 mN/m | >14 | C | Invention |
| 9 | B | B | B | Deposited | 11 nm | 18 mN/m | >14 | D | Comparative |
| | | | | | | | | | Example |
| 10 | A | A | A | Absent | <3.0 nm | 18 mN/m | >14 | C | Invention |
| 11 | A | A | A | Absent | <3.0 nm | 15 mN/m | >14 | C | Invention |
| 12 | A | A | A | Absent | <3.0 nm | 14 mN/m | >14 | C | Invention |
| 13 | B | A | C | Absent | <3.0 nm | 18 mN/m | >14 | C | Invention |
| 14 | C | A | C | Absent | <3.0 nm | 22 mN/m | >14 | C | Invention |
| 15 | D | A | D | Present | 6.0 nm | 25 mN/m | >14 | C | Invention |
| 16 | A | B | A | Absent | <3.0 nm | 17 mN/m | >14 | C | Comparative |
| | | | | | | | | | Example |
| 17 | D | A | C | Present | 7.5 nm | 24 mN/m | >14 | B | Comparative |
| | | | | | | | | | Example |
| 18 | B | A | C | Slightly | 5.5 nm | 17 mN/m | >14 | C | Invention |
| | | | | Present | | | | | |
| 19 | A | A | A | Absent | <3.0 nm | 15 mN/m | >14 | C | Invention |
| 20 | A | A | A | Absent | <3.0 nm | 15 mN/m | >14 | C | Invention |
| 21 | D | A | E | Absent | <3.0 nm | 15 mN/m | >14 | C | Comparative |
| | | | | | | | | | Example |
| 22 | A | A | E | Absent | <3.0 nm | 17 mN/m | >14 | D | Comparative |
| | | | | | | | | | Example |
| 23 | A | A | A | Absent | <3.0 nm | 15 mN/m | >14 | C | Invention |
| 24 | B | A | B | Absent | <3.0 nm | 18 mN/m | >14 | C | Invention |

From the results shown in Table 2, it can be seen that the antireflective film according to the invention is excellent in the transfer preventing property and the scratch resistance, and that a fat or oil component, for example, a finger print or sebum attached on the antireflective film can be easily wiped off.

TABLE 3

| | | Medium | High | | | | | | |
|---|---|---|---|---|---|---|---|---|---|
| | Hardcoat | Refractive | Refractive | Low Refractive Index | | Layer Thickness | | | |
| | Layer | Index Layer | Index Layer | Layer | | | Medium | High | Low |
| Sample | Coating | Coating | Coating | Coating | Refractive | Hardcoat | Refractive | Refractive | Refractive |
| No. | Solution | Solution | Solution | Solution | Index | Layer | Index Layer | Index Layer | Index Layer |
| 25 | B | — | — | Ln 3 | 1.36 | 12 μm | — | — | 94 nm |
| 26 | C | — | — | Ln 3 | 1.36 | 12 μm | — | — | 93 nm |
| 27 | A | — | A | Ln 3 | 1.36 | 12 μm | — | 135 nm | 95 nm |
| 28 | A | A | A | Ln 3 | 1.36 | 12 μm | 55 nm | 90 nm | 100 nm |
| 29 | A | A | A | Ln 7 | 1.36 | 12 μm | 55 nm | 90 nm | 100 nm |
| 30 | A | B | B | Ln 3 | 1.36 | 12 μm | 60 nm | 110 nm | 90 nm |

| | Performances | | | | | | | | | | | | |
|---|---|---|---|---|---|---|---|---|---|---|---|---|---|
| Sam- | Fingerprint | | Steel Wool | | | | | Dust | Reflection | | | | |
| ple | Wipe-Off | Transfer | Scratch | Sea-Island Structure | | Surface | Log | Attachment | Characteristics | | | | |
| No. | Property | Property | Resistance | Microscope | Ra | Energy | SR | Property | Reflectivity | a* | b* | ΔE | Remarks |
| 25 | A | A | A | Absent | <3.0 nm | 15 mN/m | 9.4 | A | 1.10% | 2.50 | −0.2 | — | Invention |
| 26 | A | A | A | Absent | — | 15 mN/m | >14 | C | — | — | — | — | Invention |
| 27 | A | A | A | Absent | <3.0 nm | 15 mN/m | >14 | C | 0.63% | 13.9 | −22.5 | — | Invention |
| 28 | A | A | A | Absent | <3.0 nm | 15 mN/m | >14 | C | 0.22% | 0.5 | −6.8 | 3.3 | Invention |
| 29 | A | B | C | Deposited | 18 nm | 17 mN/m | >14 | D | 0.22% | 0.5 | −6.8 | 3.3 | Compar- |
| | | | | | | | | | | | | | ative |
| | | | | | | | | | | | | | Example |
| 30 | A | A | A | Absent | <3.0 nm | 15 mN/m | 10.5 | A | 0.22% | 2.0 | −8.5 | 2.5 | Invention |

In Sample No. 26 to which the antiglare property was imparted using Coating solution C for hardcoat layer, the Ra measurement by AMF could not be conducted, but the sea-island structure was not observed.

In Sample No. 27 provided with the high reflective index layer and in Sample No. 28 provided with the medium reflective index layer and the high reflective index layer, the fingerprint attached was easily recognized in comparison with the corresponding sample having only the low reflective index layer, but the fingerprint attached could be promptly wiped off. Further, in Sample No. 25 to which the antistatic property was imparted using Coating solution B for hardcoat layer, the log SR was 9.4 and in Sample No. 30 to which the conductive inorganic oxide fine particle was added, the log SR was 10.5, and in both samples the dust attachment property was ranked A. Thus, the antireflective films also improved in the dust attachment preventing property were obtained in comparison with Sample No. 28 wherein the log SR was 15 and the dust attachment property was ranked C.

### (Saponification Treatment of Antireflective Film).

Sample No. 3 of antireflective film described above was subjected to the following treatment. Specifically, an aqueous 1.5 mol/l sodium hydroxide solution was prepared and kept at 55° C. An aqueous 0.01 mol/l dilute sulfuric acid solution was prepared and kept at 35° C. The antireflective film was immersed in the aqueous sodium hydroxide solution for 2 minutes and then immersed in water to thoroughly wash away the aqueous sodium hydroxide solution. Subsequently, the antireflective film was dipped in the aqueous dilute sulfuric acid solution for one minute and then immersed in water to thoroughly wash away the aqueous dilute sulfuric acid solution. Finally, the antireflective film was thoroughly dried at 120° C.

Thus, the antireflective film subjected to the saponification treatment was prepared.

### (Preparation of Polarizing Plate)

A triacetyl cellulose film having a thickness of 80 μm (TAC-TA80U, produced by Fujifilm Corp.) which had been immersed in an aqueous 1.5 moll NaOH solution at 55° C. for 2 minutes, neutralized and then washed with water and the antireflective film subjected to the saponification treatment were adhered to the both surfaces of a polarizer prepared by adsorbing iodine to polyvinyl alcohol and stretching, in order to protect the both surfaces, thereby preparing a polarizing plate.

### (Preparation of Circular Polarizing Plate)

A λ/4 plate was stuck on the surface of the polarizing plate on the opposite side to the low refractive index layer with an adhesive to prepare a circular polarizing plate (Sample No. 31). Sample No. 31 was stuck on the surface of an organic EL display with an adhesive so as to face the low refractive index layer outwards. In the region where a finger print was attached on the surface of the low refractive index layer and then wiped off with ten reciprocations with tissue paper, the good display performance could also be achieved.

Sample No. 31 was used as a polarizing plate on the surface of each of a reflection type liquid crystal display and a semi-transmission type liquid crystal display so as to face the low refractive index layer outwards. In the region where a finger print was attached on the surface of the low refractive index layer and then wiped off with ten reciprocations with tissue paper, the good display performance could also be achieved.

What is claimed is:

1. An antireflective film comprising:
a transparent substrate film; and at least one low refractive index layer,
wherein the low refractive index layer is formed with a composition comprising:
(A) a fluorine-containing antifouling agent having a weight average molecular weight of less than 10,000 and a structure represented by the following formula (F);
(B) a polyfunctional monomer having a polymerizable unsaturated group; and
(C) an inorganic particle, and
a content of the fluorine-containing antifouling agent is 1% by weight or more and less than 25% by weight based on a total solid content of the coating composition:
(Rf)-[(W)-(R_{A})ₙ]ₘ Formula (F)
wherein, Rf represents a (per)fluoroalkyl group or a (per)fluoropolyether group, W represents a connecting group, R_{A} represents a functional group having a polymerizable unsaturated group, n represents an integer of from 1 to 3, and m represents an integer of from 1 to 3.

2. The antireflective film as claimed in claim 1, which has a surface energy of less than 16 mN/m.

3. The antireflective film as claimed in claim 1, which has a surface roughness determined by an atomic force microscope of less than 5 nm.

4. The antireflective film as claimed in claim 1, wherein the inorganic particle is a silica particle having a hollow structure.

5. The antireflective film as claimed in claim 1, wherein an average particle size of the inorganic particle is 15 nm or more and less than 100 nm.

6. The antireflective film as claimed in claim 1, wherein a content of the inorganic particle is 30% by weight or more based on a total solid content of the coating composition.

7. The antireflective film as claimed in claim 1, which further comprises a high refractive index layer.

8. The antireflective film as claimed in claim 1, which further comprises a medium refractive index layer and a high refractive index layer, so that the medium refractive index layer, the high refractive index layer and the low refractive index layer are provided in this order from a side of the transparent substrate film.

9. The antireflective film as claimed in claim 8, wherein at least one of the medium refractive index layer and the high refractive index layer comprises a conductive inorganic particle.

10. The antireflective film as claimed in claim 9, wherein the conductive inorganic particle comprises one or more metal oxides selected from the group consisting of tin-doped indium oxide, antimony-doped tin oxide, fluorine-doped tin oxide, phosphorous-doped tin oxide, zinc antimonite, indium-doped zinc oxide, zinc oxide, ruthenium oxide, rhenium oxide, silver oxide, nickel oxide and copper oxide.

11. The antireflective film as claimed in claim 8, wherein tint of regular reflecting light for incident light at an angle of 5 degree of a CIE standard light source D65 in a wavelength range from 380 to 780 nm satisfies following conditions that a* value and b* value in CIE1976 L*a*b* color space are in ranges of 0≦a*≦8 and −10≦b*≦0, respectively, and within the tint variation range, a color difference AE due to 2.5% fluctuation in a thickness of at least one layer contained in the antireflective film falls in a range of the following equation (5):
ΔE={(L*−L*′)²+(a*−a*′)²+(b*−b*′)²}^{1/2}≦3 Equation (5)
wherein L*′, a*′ and b*′ indicate tint of reflected light at a designed film thickness.

12. The antireflective film as claimed in claim 1, which further comprises a hardcoat layer.

13. The antireflective film as claimed in claim 12, wherein the hardcoat layer comprises a conductive compound.

14. A polarizing plate comprising two protective films and a polarizing film provided between the protective films, wherein at least one of the protective films is the antireflective film as claimed in claim 1.

15. An image display device, wherein the antireflective film as claimed in claim 1 is provided at an outermost surface of the display.

16. A coating composition comprising:
(A) a fluorine-containing antifouling agent having a weight average molecular weight of less than 10,000 and a structure represented by the following formula (F);
(B) a polyfunctional monomer having a polymerizable unsaturated group; and
(C) an inorganic particle,
wherein a content of the fluorine-containing antifouling agent is 1% by weight or more and less than 25% by weight based on a total solid content of the coating composition, and components of the coating composition other than the fluorine-containing antifouling agent do not contain a fluorine atom:
(Rf)-[(W)-(R_{A})ₙ]ₘ Formula (F)
wherein, Rf represents a (per)fluoroalkyl group or a (per)fluoropolyether group, W represents a connecting group, R_{A} represents a functional group having a polymerizable unsaturated group, n represents an integer of from 1 to 3, and m represents an integer of from 1 to 3.

17. The antireflective film as claimed in claim 1, wherein components of the composition for forming the low refractive index layer other than the fluorine-containing antifouling agent do not contain a fluorine atom.
